(19) United States
(12) Patent Application Publication
(10) Pub. No.: US 2008/0043257 A1
(43) Pub. Date: Feb. 21, 2008

(54) Image processing device and method for generating a conversion table

(76) Inventors: Satoshi Yamazaki, Shiojiri-shi (JP); Toshiaki Kakutani, Shiojiri-shi (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/654,902

(22) Filed: Jan. 17, 2007

(30) Foreign Application Priority Data
Jan. 18, 2006 (JP) 2006-10169

(51) Int. Cl. G06K 15/10

(52) U.S. Cl. 358/1.8

(57) ABSTRACT

Small area dither matrices including a consolidation of a specified number of threshold values are taken out from within a large area dither matrix, and the plurality of threshold values contained in this are realigned in size sequence and recorded, and initial data is prepared in which is recorded arrangement restoration data representing the arrangement of the threshold values within this small area dither matrix. Then, for each small area dither matrix, a dot arrangement pattern is generated across the scope of the values that the image data can have based on the previously described threshold value data and arrangement data, and this is recorded in the conversion table. By working in this way, it is possible to easily realize the process of converting image data to a dot arrangement pattern formed on the printing medium.

### CLAIM OF PRIORITY

The present application claims priority from Japanese application P2006-10169A filed on Jan. 18, 2006, the content of which is hereby incorporated by reference into this application.

### BACKGROUND

1. Field of the Invention

The present invention relates to a technique of generating a conversion table for generating multi-gradation image data for expressing an image to a plurality of types of dot arrangement patterns formed on a printing medium.

2. Description of the Related Art

In recent years, in the field of inkjet printers which form images by ejecting tiny ink drops on a printing medium, by varying the size of the ejected ink drops, the sizes of the dots formed on the printing medium are given multiple values, in an attempt to improve image quality.

For example, with the technique developed by the applicant of this application, a unique halftone processing method is used which is different from the halftone processes of the prior art which are the dither method and the error diffusion method. With this technique, by varying the drive waveform of the piezo element provided within the ink head, the size of the ejected ink drops is changed to four types including large, medium, small, and none (see JP-A-2005-236768 and JP-A-2005-269527).

With the image processing techniques noted in these references, first, from the gradation values of the pixels that constitute the input image, the dot generation density of each size is determined based on the specified density table (see JP-A-2005-236768, FIG. 22). Having done this, this density data and a threshold value within a local dither matrix are compared, and the number of dots of each size generated within that dither matrix is counted (see FIG. 21 and FIG. 23 of the same patent). Then, based on the data called the sequence value matrix that defines the dot generating sequence within that dither matrix, each dot for which the generated number was counted is arranged in sequence. In this way, the image processing device generates dot arrangement pattern formed on the printing medium (see FIG. 25 and FIG. 15 of the same patent).

However, with this kind of prior art image processing technique, for converting image data to the dot arrangement pattern, multi-level processing is required such as conversion from the image data gradation value to density data, comparison with the threshold value, counting of the dot count, and the like, so the overall process was complicated.

### SUMMARY

An advance of some aspects of the invention is to easily realize the process of converting image data to a dot arrangement pattern formed on a printing medium.

A device according to an aspect of the present invention is constituted as follows.

An image processing device that converts image data to data for printing by forming dots on a printing medium, the device comprising:

a storage unit that takes out from a large area dither matrix, in which are arranged threshold values that set whether dots are on or off within a specified area, a small area dither matrix that is an area smaller than that, including a consolidation of a specified number of threshold values, and stores threshold value data for which the plurality of threshold values contained in each of the small area dither matrices are realigned in size order and initial data on which is recorded arrangement restoration data representing an arrangement of the threshold values within each of the small area dither matrices; and

a conversion table generating unit that generates a conversion table based on the threshold value data and the initial data provided at each of the small area dither matrices, the conversion table is used for converting the image data to a dot arrangement pattern.

A method according to an aspect of the present invention is constituted as follows.

A method of generating a conversion table that converts the image data to dot data for printing by forming dots on a printing medium, the method comprising:

preparing a large area dither matrix in which are arranged threshold values that set whether dots within a specified area are on or off,

taking out a small area dither matrix including a consolidation of a specified number of threshold values from the large area dither matrix, the small area dither matrix is an area smaller than that;

realigning in size sequence a plurality of threshold values contained in each of the small area dither matrices,

generating arrangement restoration data that represents an arrangement of threshold values within each of the small area dither matrices, and

generating the conversion table based on the threshold value data and the arrangement restoration data provided at each of the small area dither matrices, the conversion table is used for converting the image data to an arrangement pattern of the dots.

With the image processing device and the conversion table generating method, for each small area dither matrix taken from a large scale dither matrix, based on the initial data, it is possible to generate in advance a conversion table for converting image data to a dot arrangement pattern. The initial data is the data in which are recorded the threshold values realigned in size order, and the arrangement restoration data representing the arrangement of the threshold values. Therefore, if this conversion table is generated, by referencing this conversion table, it is possible to easily convert image data to a dot arrangement pattern. As a result, it becomes possible to accelerate the printing process.

Note that for the aspect of the present invention, in addition to the constitution as the image processing device described above, it is also possible to constitute this as initial data used by the concerned image processing device for generating a conversion table for converting image data to a dot arrangement pattern, or a computer program for the image processing device to generate the conversion table. It is also possible to have the initial data or computer program be recorded on a computer readable recording medium. As recording media, for example, it is possible to use various types of media such as a flexible disk, CD-ROM, DVD-ROM, optical magnetic disk, memory card, hard disk, or the like. It is also possible to save the initial data or conversion table, or the program for generating the conversion table, on a server, and to use this via a network.

### BRIEF DESCRIPTION OF THE DRAWINGS

FIG. 1 is an explanatory drawing showing a printer 100 as an embodiment of the present invention.

FIG. 2 is an explanatory drawing showing the internal constitution of the printer 100.

FIG. 3A and 3B are explanatory drawings showing the principle of different size ink droplets being ejected from the ink head 211.

FIG. 4 is an explanatory drawing showing the detailed constitution of an image processing ASIC 155.

FIG. 5 is an explanatory drawing showing an example of the dot arrangement data.

FIG. 6 is a flow chart of the printing process executed by the printer 100.

FIG. 7 is a flow chart showing the details of the initialization process.

FIG. 8 is an explanatory drawing showing the data constitution of the dither data DthDAT and the principle of generating that.

FIG. 9 is an explanatory drawing showing an example of the dot generating volume table DGTBL.

FIG. 10 is an explanatory drawing showing the data constitution of the decoding table DecTBL.

FIG. 11 is an explanatory drawing showing the data constitution of the encoding threshold value table ETTBL.

FIG. 12 is an explanatory drawing showing the data constitution of the encoding table EncTBL.

FIG. 13 is an explanatory drawing typically showing the change of encoded values recorded in the encoding table EncTBL.

FIG. 14 is a flow chart showing the details of the decoding table generating process.

FIG. 15 is a flow chart showing the details of the dot count counting process.

FIG. 16 is an explanatory drawing showing an example of the dot count data DCDAT.

FIG. 17 is an explanatory drawing showing a specific example of the dot count counting process.

FIG. 18 is a detailed flow chart of the dot arrangement data generating process.

FIG. 19 is an explanatory drawing typically representing the dot arrangement data generating process.

FIG. 20 is a detailed flow chart of the encoding table generating process.

FIG. 21 is a detailed flow chart of the halftone process.

FIG. 22 is a flow chart representing the details of the encoding process.

FIG. 23 is a detailed flow chart of the decoding process.

FIG. 24 is an explanatory drawing showing a modification of the dither data.

FIG. 25 is a flow chart of the dot arrangement data generating process for the modification.

FIG. 26 is an explanatory drawing showing an example of the extension sequence value data table XTBL.

FIG. 27 is an explanatory drawing showing an example of dot arrangement data when extension sequence value data is applied and dot arrangement data when it is not applied.

FIG. 28 is an explanatory drawing showing an example of a first conversion table DT1 used for the decoding process of the modification.

FIG. 29 is an explanatory drawing showing an example of a second conversion table DT2 used for the decoding process of the modification.

FIG. 30 is a flow chart of the decoding process executed by a decoding unit 420 with the modification.

FIG. 31 is an explanatory drawing showing the difference in the actual size of the output of one block for the high resolution mode and the low resolution mode.

FIG. 32 is a flow chart representing a summary of the halftone process when in the low resolution mode.

### DESCRIPTION OF THE PREFERRED EMBODIMENTS

Following, aspects of implementing the present invention are described based on embodiments in the following order to make even more clear the operation and effects of the present invention described above.
A. Printer Constitution:
B. Printing Process:
C. Initialization Process:
D. Decoding Table Generating Process:
E. Encoding Table Generating Process:
F. Halftone Process:
G. Effect:
H. Modifications:
I. Other Aspects:

A. Printer Constitution:

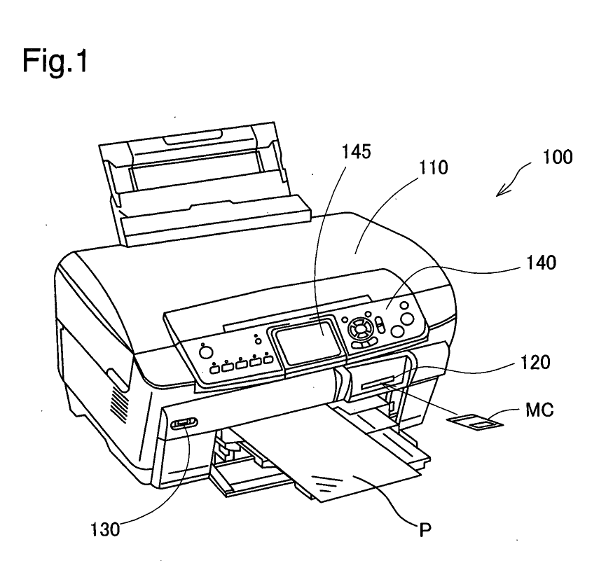

FIG. 1 is an explanatory drawing showing a printer 100 as an embodiment of the present invention. The printer 100 is a so called compound type printer, including a scanner 110 that reads images optically, a memory card slot 120 for inserting a memory card MC on which is recorded image data, a USB interface 130 that connects devices such as a digital camera or the like, and the like. The printer 100 is able to print on printing paper P images taken by the scanner 110, images read from the memory card MC, images read from a digital camera via the USB interface 130, and the like. It is also possible to print images input from a personal computer (not illustrated) connected by a printer cable or the like.

The printer 100 has an operating panel 140 for performing various setting operations related to printing such as selection of the image to be printed, setting of the type and size of printing paper, and the like. At the center of the operating panel 140 is a liquid crystal monitor 145. On the liquid crystal monitor 145 are displayed a list of images input from the memory card MC or the like or various graphical interfaces (GUI).

As will be described later, the printer 100 has a function of performing color printing using six colors of ink, cyan (C), light cyan (Lc), magenta (M), light magenta (Lm), yellow (Y), and black (K). Also, the printer 100 is equipped with a function of adjusting the size of the dots ejected onto the printing paper to four levels when performing color printing using these six colors of ink. With the description hereafter, adjusting the dot size to four levels is called “four value conversion.”

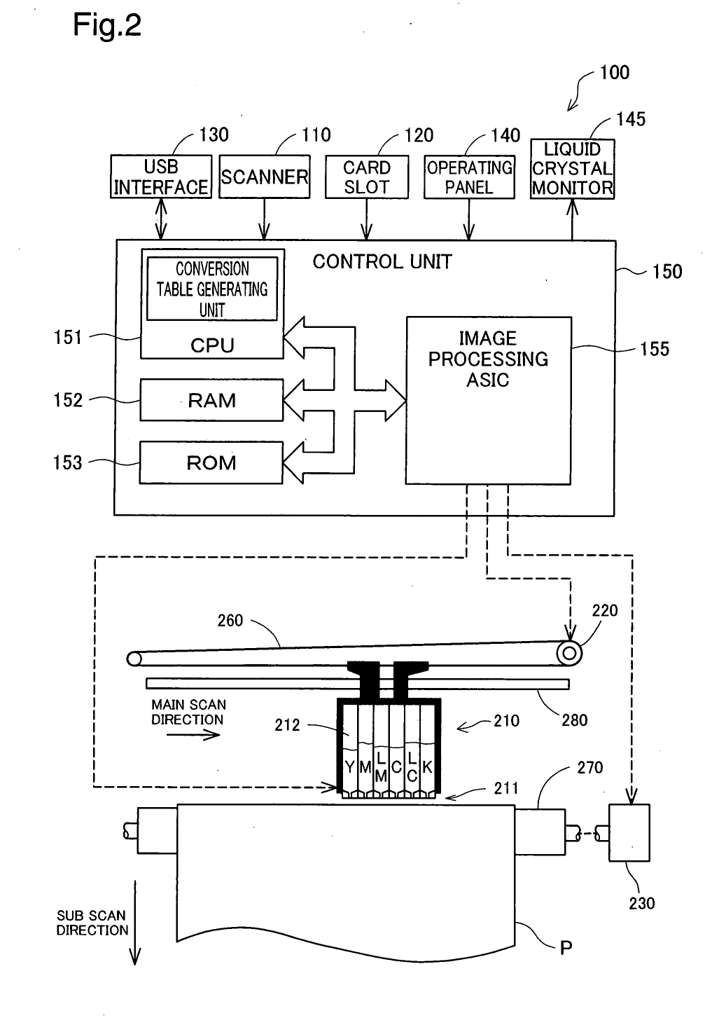

FIG. 2 is an explanatory drawing showing the internal constitution of the printer 100. As shown in the drawing, the printer 100 has as a mechanism for performing printing on the printing paper P, a carriage 210 on which is placed an ink cartridge 212, a carriage motor 220 for driving the carriage 210 in the main scan direction, a paper feed motor 230 for conveying the printing paper P in the sub scan direction, and the like.

On the carriage 210 are mounted ink cartridges 212 in which each ink of cyan (C), light cyan (Lc), magenta (M), light magenta (Lm), yellow (Y), and black (K) is housed. The carriage 210 has a total of six types of ink head 211 corresponding to these colors. The ink supplied from the ink cartridge 212 to the ink heads 211 is ejected onto the printing paper P by the piezo elements (not illustrated) being driven.

The carriage 210 is held to be able to move freely on a sliding axis 280 installed in parallel with the axis direction of the platen 270. The carriage motor 220 moves the carriage 210 back and forth parallel to the axis direction of the platen 270, specifically, the main scan direction, by rotating the drive belt 260 according to the instructions from the control unit 150.

The paper feed motor 230 conveys the printing paper P perpendicular to the axis direction of the platen 270 by rotating the platen 270 according to instructions from the control unit 150. In other words, the paper feed motor 230 is able to move the carriage 210 relative to the sub scan direction.

The printer 100 is equipped with a control unit 150 for controlling the operation of the ink head 211, the carriage motor 220, and the paper feed motor 230 described above. Connected to the control unit 150 are the scanner 110, the memory card slot 120, the USB interface 130, the operating panel 140, and the liquid crystal monitor 145 shown in FIG. 1.

The control unit 150 is constituted by a CPU 151, a RAM 152, a ROM 153, and an image processing ASIC 155.

Recorded in the ROM 153 is a control program for doing general control of the operation of the printer 100. The CPU 151 executes reading of this control program to the RAM 152 when the power of the printer 100 is turned on. The CPU 151 performs the printing process, initialization process and the like described later by execution of this control program. Also, recorded in the ROM 153 are the dither data DthDAT and dot generating volume table DGTBL used during the initialization process described later.

The CPU 151, in addition to using the RAM 152 as temporary memory during execution of the control program, also uses this for the application of temporarily storing image data read from the memory card MC. The CPU 151 also stores the encoding table EncTBL and the decoding table DecTBL generated with the initialization process described later in the RAM 152. The encoding table EncTBL and the decoding table DecTBL correspond to the “conversion table” of this application.

The image processing ASIC 155 is an integrated circuit for performing a series of processes for printing an image by implementing color conversion processing or halftone processing on the image data input from the CPU 151, the memory card MC or the like, and controlling the printing mechanisms (ink head 211, carriage motor 220, paper feed motor 230).

The printer 100 of this embodiment is able to form four types of sized of dots by controlling the ink head 211 using the control unit 150 and converting to four levels the size of the ink drops ejected on the printing paper P. Following, including when there are no dots formed, the four types of dot sizes are called “no dots,” “S dots,” “M dots,” and “L dots” in sequence from the small size.

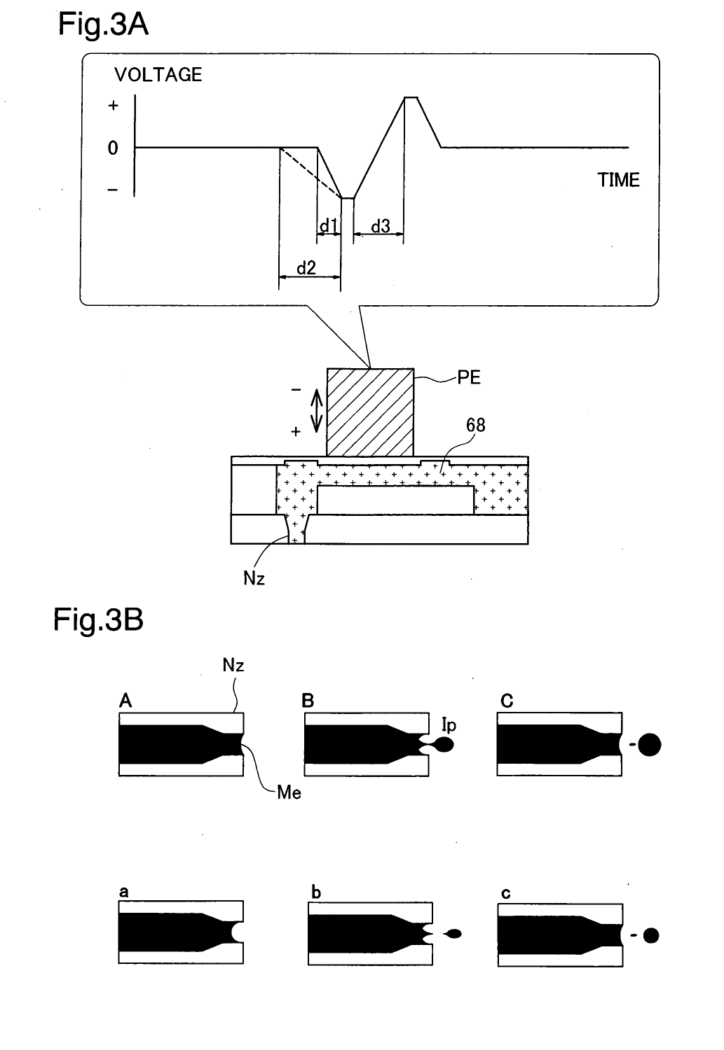

FIG. 3A and 3B are explanatory drawings showing the principle of different sized ink drops being ejected from the ink head 211. For the voltage waveform shown in FIG. 3A, the waveform shown by the dashed line is the waveform when normal dots are ejected. In this voltage waveform, at section d2, when a minus voltage is applied to the piezo element PE once, the piezo element PE is deformed in a direction enlarging the cross section area of the ink path 68. By doing this, because there is a limit to the supply speed of the ink from the ink cartridge 212, the supply volume of the ink is insufficient in relation to the expansion of the ink path 68. As a result, in FIG. 3B, as shown as the status A, the interface Me of the ink of the nozzle Nz tip is drawn within the nozzle Nz and is in a concave state.

Meanwhile, using the voltage waveform shown by the solid line, when a minus voltage is applied rapidly to the piezo element PE as shown in section d1 in FIG. 3A, the status is that there is even more insufficiency of the ink supply volume from the ink cartridge 212. Therefore, as shown by status a, the status is such that the ink interface Me is even further drawn into the nozzle Nz compared to status A. Next, when a positive voltage is applied to the piezo element PE (section d3), the ink path 68 becomes narrow, and the ink is ejected. At this time, from a state for which the ink interface Me is not bent very far to the inside (status A in FIG. 3B), large ink drops are ejected as shown with status B and status C. In contrast to this, from a state for which the ink interface Me is greatly bent far to the inside (status a in FIG. 3B), small ink drops are sprayed as shown by status b and status c. In this way, by adjusting the voltage waveform applied to the piezo element PE, it is possible to eject ink drops of different sizes from the ink head 211.

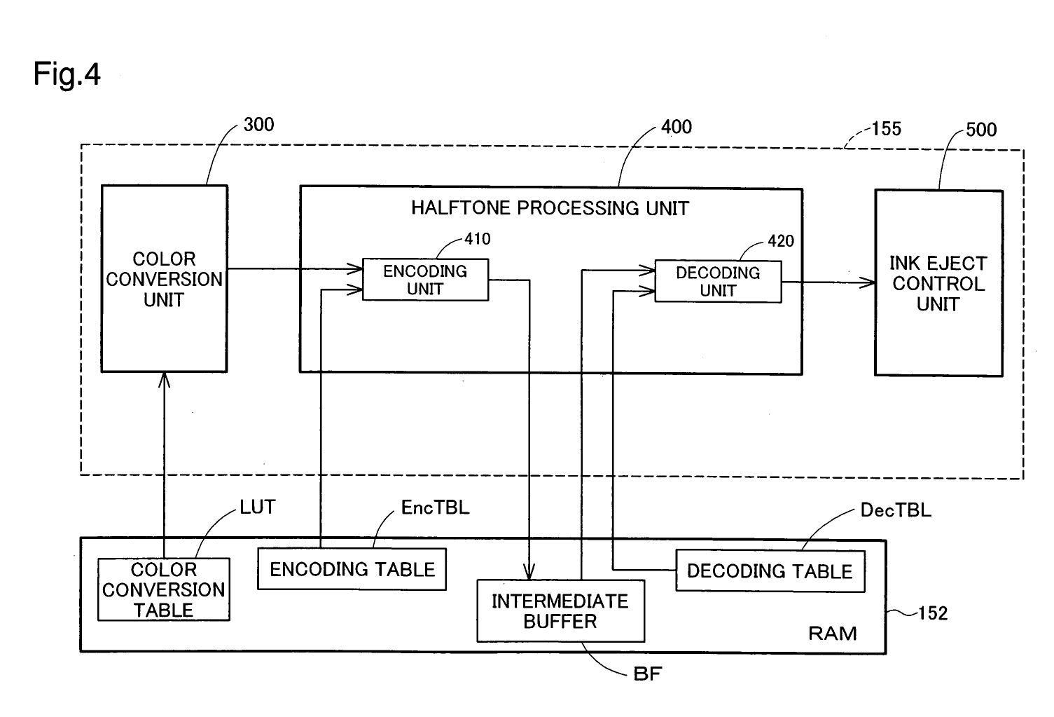

FIG. 4 is an explanatory drawing showing the detailed structure of the image processing ASIC 155 shown in FIG. 2. As shown in the drawing, the image processing ASIC 155 of this embodiment is equipped with a color conversion unit 300, a halftone processing unit 400, and an ink eject control unit 500.

The color conversion unit 300 is a circuit for converting the image data colors expressed by a combination of gradation values of R, G, and B to colors expressed by a combination of gradation values for each color of ink equipped in the carriage 210. As described previously, the printer 100 prints images using a maximum of six colors of ink including C, M, Y, K, Lc, and Lm. In light of this, the color conversion unit 300 converts image data expressed by each color RGB to image data expressed by gradation values of these six colors.

The color conversion unit 300 performs the color conversion described previously by referencing a table called a color conversion table LUT stored in the RAM 152. In this color conversion table LUT are stored RGB gradation values and CMYKLcLm gradation values that have been correlated in advance. By referencing this color conversion table LUT, the color conversion unit 300 is able to rapidly convert image data expressed in the RGB format to image data in the CMYKLcLm format (hereafter referred to as the “CMY format”). The image data after the color conversion has 256 levels (0 to 255) of gradation values.

The halftone processing unit 400 is a circuit that inputs the CMY format image data that was color converted by the color conversion unit 300, and converts this image data to dot arrangement data representing the dot arrangement pattern formed on the printing medium.

The CMY format image data is data which has 256 gradations respectively for each color CMYKLcLm for each pixel, but the printer 100 can only adjust the size of the sprayed ink drops to a maximum of four levels, and cannot reproduce the 256 gradations on the printing paper using the CMY format data as is. Because of that, using the halftone processing unit 400, the printer 100 expresses intermediate gradation colors by converting the CMY format gradation values to dot arrangement data representing dot coarseness for each unit surface area.

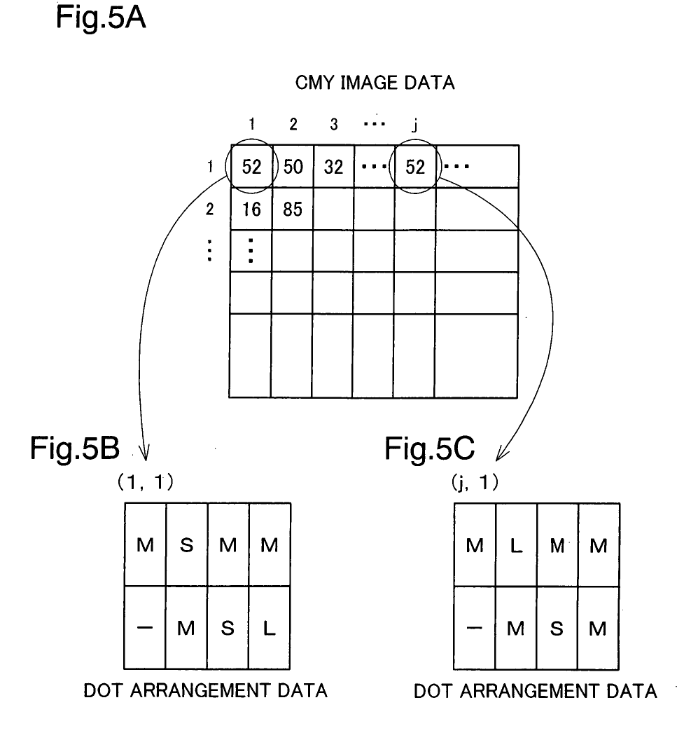

FIG. 5 is an explanatory drawing showing an example of dot arrangement data. With this FIG. 5, an example of CMY format image data is shown in (a). When the gradation value of the color of pixel (1, 1) at the farthest upper left of the CMY image data shown in FIG. 5(a) is “52,” an example of this converted to dot arrangement data is shown in FIG. 5(b). In this way, with this embodiment, when the gradation values of one pixel are input, within a 4×2 dot group, S dots, M dots, L dots and the like are arranged, and a color represented by those gradation values is expressed on the printing paper. Note that the dot group described above is sometimes called a “block” hereafter.

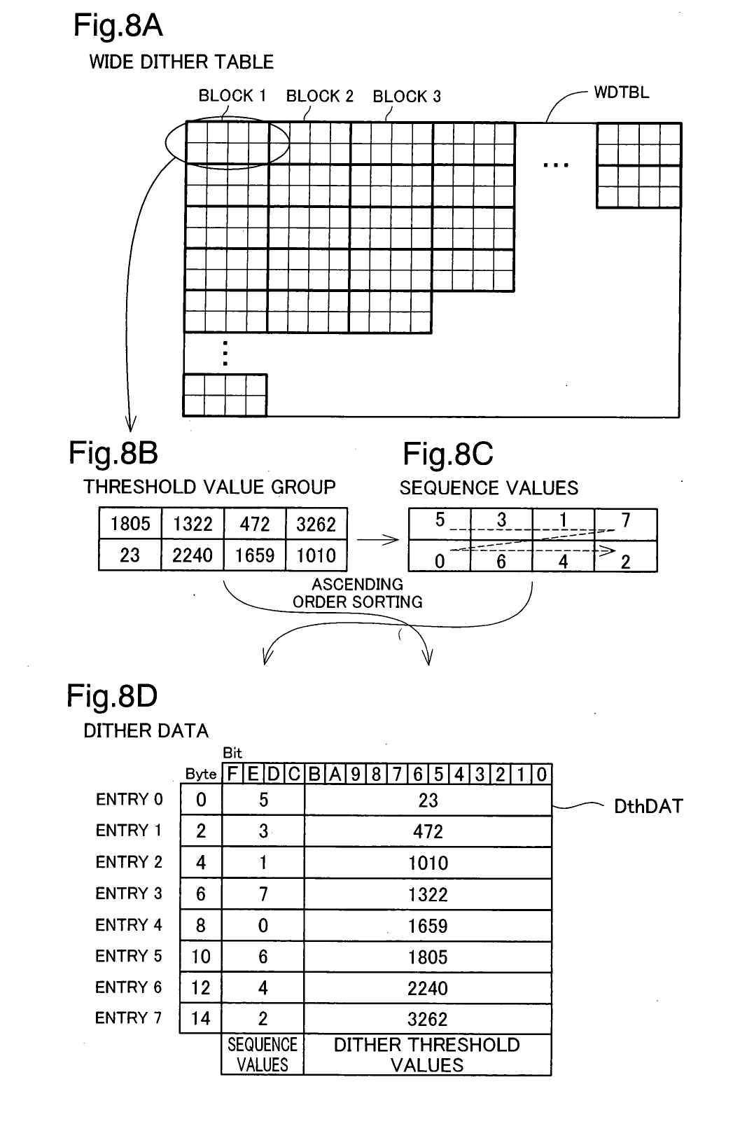

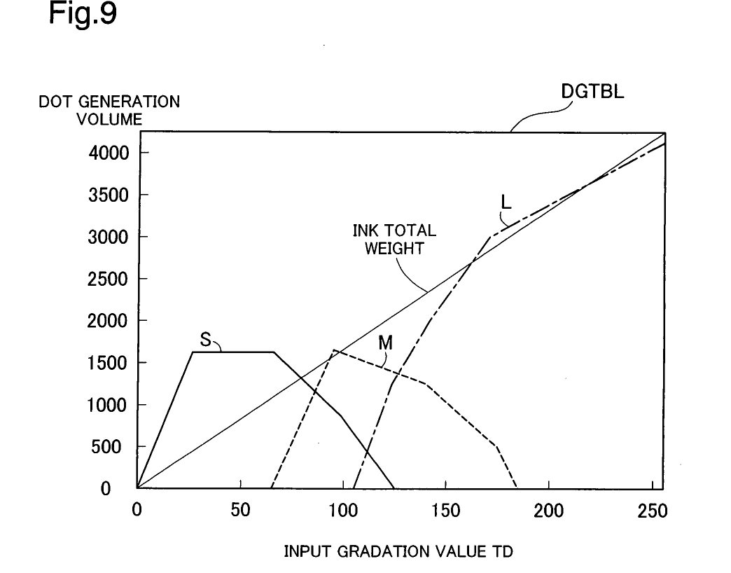

Here, we give a brief description of the method of generating the dot arrangement data. The arrangement of each dot within the dot arrangement data is determined by the relationship between the local threshold value group (see FIG. 8(b)) cut from the wide dither table according to the dot group size and to the position of the pixels subject to conversion, and the generated volume of the dots of each size corresponding to the gradation values of that pixel (see FIG. 9). In other words, using the dot generating volume table shown in FIG. 9, the generating volume of the dots of each size is found according to the gradation value, a comparison is made of the generating volume for each dot and the threshold value within the threshold group, and the number of dots of each size to arrange within one block is found. Then, the dot arrangement data is generated by arranging that number of dots from the large size dots in sequence of the low threshold value locations. A detailed description of this process is given later.

With this embodiment, even when the gradation value of the pixel in the CMY image is the same, if the position of the pixel subject to halftone processing is different, the applied threshold value group is different, so there are cases when different dot arrangement data is generated. For example, other than the pixel at the farthest upper left of the CMY image shown in FIG. 5(a), we will assume there is one more pixel (j, 1) having a gradation value of “52.” The example of the dot arrangement data corresponding to this pixel is shown as (c) in FIG. 5, but this dot arrangement data has a different dot arrangement from that of the dot arrangement data shown previously. In other words, with this embodiment, in addition to the value of the gradation values, the generated dot arrangement data also changes according to the position of the pixel subject to halftone processing, so it is possible to perform higher image quality image output than with the prior art ordered dither method, density pattern method and the like.

As described above, with this embodiment, because the dot group unit was 4×2, for example, if the input image resolution is 360 dpi×360 dpi, then the output resolution output to the printing paper will be 1440 dpi×720 dpi. The reason that the dot group horizontal direction resolution was made higher than the vertical direction resolution is because the following capability of the human eye for gradation changes has higher sensitivity in the horizontal direction than in the vertical direction. Also, it is relatively easier to do control moving the carriage 210 in the main scan direction than it is to do control moving the printing paper P in the sub scan direction, so the horizontal direction resolution is made higher than the vertical direction resolution. However, of course, the dot group size, in addition to 4×2, can also be 4×4 or 2×2 or the like with an equal aspect ratio. Note that with the description hereafter, the smallest unit of the structural component of the RGB format or CMY format images is called a “pixel,” and the smallest unit of the structural component of the output image formed on the printing paper P is called a “dot.” Note that the plurality of pixels in the RGB format or CMY format images are consolidated as 4×2 or 2×2 blocks, so it is also possible to handle the pixels representing the plurality of pixels (e.g. items for which the gradation values of the pixels within a block are averaged) as the “pixels” described above.

The description now returns to FIG. 4. The halftone processing unit 400 is equipped with an encoding unit 410 and a decoding unit 420.

With the halftone processing unit 400, when CMY format image data is input from the color conversion unit 300, this image data is input to the encoding unit 410.

The encoding unit 410 converts the gradation values of each pixel constituting the input image data to encoded values represented by 5-bit data by referencing the encoding table EncTBL stored in the RAM 152. This conversion process is hereafter referred to as the “encoding process.” The encoded value obtained by the encoding process is a value indicating what kind of dot arrangement data (see FIG. 5) is formed on the printing paper. The reason that the encoded value is held within a data width of 5 bits is because with the decoding table generating process described later, the combination count when the various size dots within the 4×2 dot group are arranged results as a maximum of 32 combinations.

When the encoding unit 410 converts gradation values represented by 8 bits to 5-bit encoded values, these encoded values are stored as intermediate data in the intermediate buffer BF secured in a specified area of the RAM 152. In this way, with this embodiment, it is possible to convert the image data input from the memory card MC or the like from 8-bit data to 5-bit data and store it in the RAM 152, so the capacity used of the RAM 152 decreases, and it is possible to reduce costs. The method of generating the encoding table EncTBL referenced with the encoding processing process and the encoding process details are described later.

By reading the encoded value from the intermediate buffer BF, and referencing the specified decoding table DecTBL stored in the RAM 152, the decoding unit 420 converts this encoded value to dot arrangement data of 4×2 dots. This conversion process is called the “decoding process” hereafter. The method of generating the decoding table DecTBL referenced with the decoding processing process and the decoding process details are described later.

When the decoding unit 420 converts the encoded value to dot arrangement data, that dot arrangement data is output to the ink eject control unit 500.

The ink eject control unit 500 controls the ink head 211, the carriage motor 220, and the paper feed motor 230, and forms dots on the printing paper based on the dot arrangement data input from the halftone processing unit 400. The ink eject control unit 500 adjusts the voltage waveform applied to the piezo element within the ink head 211 according to the types of dots recorded in the input dot arrangement data and sprays the ink drops, and performs division of different sized dots. By doing this, the printer 100 of this embodiment performs color printing on the printing paper.

B. Printing Process:

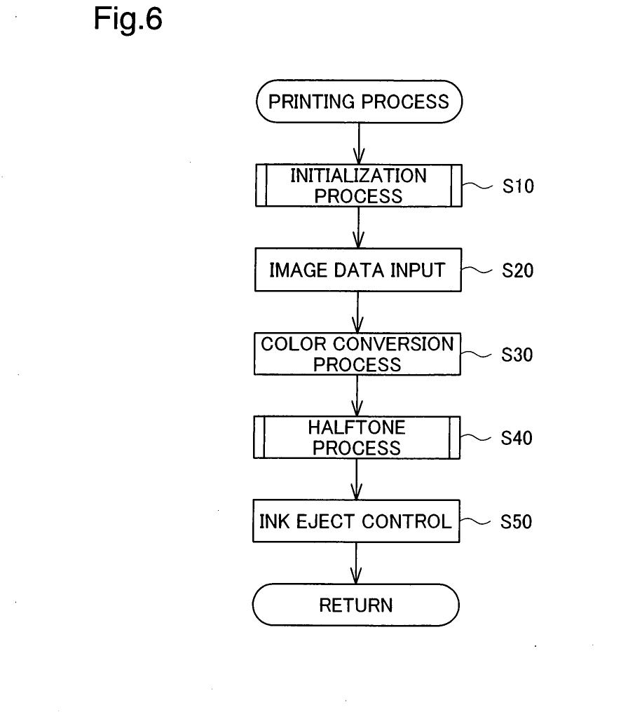

FIG. 6 is a flow chart of the printing process executed by the printer 100. This printing process is a process executed by the CPU 151 when the image data to print is selected by the operation of the operating panel 140 by the user and a specified print button is operated.

When this printing process is executed, the CPU 151 first performs the initialization process for generating the encoding table EncTBL and the decoding table DecTBL shown in FIG. 4 (step S10). A detailed description of this initialization process is given later.

When the initialization process is completed, the CPU 151 inputs the image data specified by the user from the memory card MC or the like (step S20). Then, the input image data is output to the image processing ASIC 155. When this is done, at the image process ASIC 155, the color conversion process by the color conversion unit 300 (step S30) and the halftone process by the halftone processing unit 400 (step S40) are performed, and dot arrangement data is generated for each pixel of the input image. A detailed description of the halftone process performed by the image processing ASIC 155 is given later.

When dot arrangement data is generated by the halftone processing unit 400, ink eject control is performed by the ink eject control unit 500 (step S50). As a result, a color image is printed on the printing paper.

C. Initialization Process:

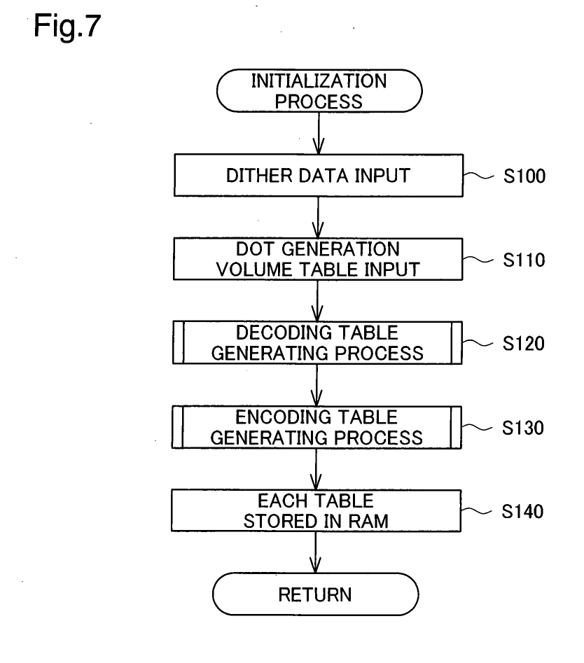

FIG. 7 is a flow chart showing the details of the initialization process executed at step S10 of the printing process described above. As shown in the drawing, when this initialization process is executed, first, the CPU 151 inputs from the ROM 153 the dither data DthDAT which becomes the generation source for the encoding table EncTBL and the decoding table DecTBL (step S100).

FIG. 8 is an explanatory drawing showing the data structure and generating principle of the dither data DthDAT corresponding to the “initial data” of this application. Before describing the data structure of the dither data DthDAT, first, we will describe the wide dither table WDTBL which is the generating source for the dither data DthDAT. FIG. 8(a) is a typical drawing of this wide dither table WDTBL. With this embodiment, the wide dither table WDTBL has a total of 4096 elements with horizontal 128×vertical 32. This wide dither table WDTBL is the same type of table as the dither table used with the ordered dither method known as the prior art halftone technology. Because of that, for the wide dither table WDTBL shown in the drawing as well, when binarizing the image data having multiple gradations, so as to have the dispersibility of black and white dots be as high as possible, 4096 types (=128×32) of threshold values from 0 to 4095 are arranged in each element. Note that an illustration of each value is omitted in FIG. 8(a).

The dither data DthDAT generating method is as follows. Specifically, first, with 4×2 elements as one block, the wide dither table WDTBL is divided into a total of 512 (=(128/4)×(32/2)) blocks, and a block number is given to each block. With this embodiment, as shown by the upper part of the drawing, the block number “1” is given to the block positioned at the farthest upper left of the wide dither table WDTBL, and the block number “2” is given to the block positioned adjacent to the right of that.

In this way, when a block number is given to each block, as shown in FIG. 8(b), from the wide dither table WDTBL, each block is taken as the threshold value group which is a small area dither matrix of an area smaller than this, and the eight threshold values recorded within this threshold value group are realigned in ascending sequence and recorded in the dither data DthDAT corresponding to the block number of that threshold value group. Because values from 0 to 4095 are recorded as threshold values in the wide dither table WDTBL, the threshold values have data capacity of a maximum of 12 bits. In light of this, with this embodiment, as shown in FIG. 8(d), one dither data DthDAT has a total data capacity of 16 bytes of 8 entries×2 bytes, with threshold value data recorded in the lower 12 bits within one entry.

As described previously, the threshold value is 12-bit data, and each entry of the dither data DthDAT has 2-byte capacity, so for each entry, there are 4 bits of capacity remaining. In light of this, with this embodiment, data called a “sequence value” is recorded in this remaining 4-bit part. This sequence value corresponds to the “arrangement restoration data” of this application.

FIG. 8(c) shows an example of the sequence value. This sequence value is generated based on the threshold value group shown in FIG. 8(b). Specifically, for example, when the gradation value rises from 0 to 4095 simultaneously for all the elements in the threshold group shown in FIG. 8(b), in the sequence 23, 472, 1010, 1322, . . . , the gradation value exceeds the threshold value. In this way, the item that defines the sequence for which the gradation value exceeds the threshold value is the sequence value shown in FIG. 8(c). Specifically, this sequence value represents the arrangement of the threshold values within the corresponding block, and when dots are generated within that block, represents the sequence in which the dots of each element within the block are generated. One block is constituted from 8 elements, so the sequence value has 8 types of values from 0 to 7. Specifically, the value of the sequence value is able to represent data of maximum 3 bits, so it is possible to record this in the upper 4 bits remaining in each entry of the dither data DthDAT.

As shown in FIG. 8(c), the sequence value is fetched from the farthest upper left element to the lower right element, and as shown in FIG. 8(d), that value is recorded in the upper 4 bits of each entry of the dither data DthDAT.

As described above, the dither data DthDAT has 8 threshold values recorded in ascending order and 8 sequence values for which the dot generation sequence is defined for each block fetched from the wide dither table WDTBL. Note that the 8 threshold values are recorded in ascending order, and the sequence value is recorded according to its position, so there is no correlation to the combination of the one set of threshold values and sequence values recorded within 1 entry of the dither data DthDAT.

At step S100 of FIG. 7, the dither data DthDAT of all the block numbers are input from the ROM 153 to the RAM 152. The threshold values within the dither data DthDAT input in this way will be used for generating the encoding threshold value table ETTBL described later, and the sequence values will be used to generate the decoding table DecTBL described later. Each dither data DthDAT is input consecutively in the block number sequence within the RAM 152. Because of that, even if a block number is not given to the dither data DthDAT itself, by performing a specified address calculation multiplying the block number by 16 bytes (=2 bytes×8 entries), the CPU 151 is able to read the dither data DthDAT of any block number from the RAM 152. It is also possible to store a combination of the block number and its corresponding dither data DthDAT.

Here, the description returns to FIG. 7. When the dither data DthDAT is input from the ROM 153, the CPU 151 subsequently inputs the dot generating volume table DGTBL which is the source for generating the encoding table EncTBL and the decoding table DecTBL from the ROM 153 to the RAM 152 (step S110).

FIG. 9 is an explanatory drawing showing an example of the dot generating volume table DGTBL. As shown in the drawing, the S dot, M dot, and L dot generating volumes are respectively defined on the vertical axis according to the input gradation value TD shown on the horizontal axis in this dot generating volume table DGTBL. According to this drawing, only the S dots are generated with an input gradation value TD of 0 to 70, and after that, we can see that both the S dots and M dots are generated from the input gradation value TD up to 120. Also, when the input gradation value TD is at level 110, in addition to the S dots and M dots, L dots are also generated, and when the input gradation value TD roughly reaches 180 or more, only L dots are generated. Note that the dot generating volume shown in the vertical axis uses values from 0 to 4095, the same as the threshold values recorded in the wide dither table WDTBL so as to be able to compare with the threshold values within the dither data DthDAT for the dot count counting process described later.

FIG. 9 shows the change in the generated volume of the S dots, M dots, and L dots, as well as in the total weight of the ink sprayed when these dots are formed on the printing medium. With the changes in the ink total weight shown in the drawing, as the input gradation value TD increases, the ink total weight also gradually increases. For the generating volume of each size dot, the respective generating volumes are set to match the change in the concerned total weight. Note that this dot generating volume table DGTBL can also be prepared according to the type of printing paper that the printer 100 supports. In this case, the corresponding dot generating volume table DGTBL is input according to the type of paper selected by the user when set at the time of printing. By working in this way, it becomes possible to perform printing suited to the selected printing paper.

The description returns to FIG. 7. With the process above, when the dither data DthDAT and the dot generating volume table DGTBL are input, the CPU 151 performs the process of generating the decoding table DecTBL and the encoding threshold value table ETTBL based on the input dither data DthDAT and the dot generating volume table DGTBL (step S120). Following, the process of this step S120 is simply called the “decoding table generating process.”

The decoding table generating process is a complex process, so a detailed description will be given later, and here, we will describe the data structure of the decoding table DecTBL and the encoding threshold value table ETTBL obtained as a result of this decoding table generating process.

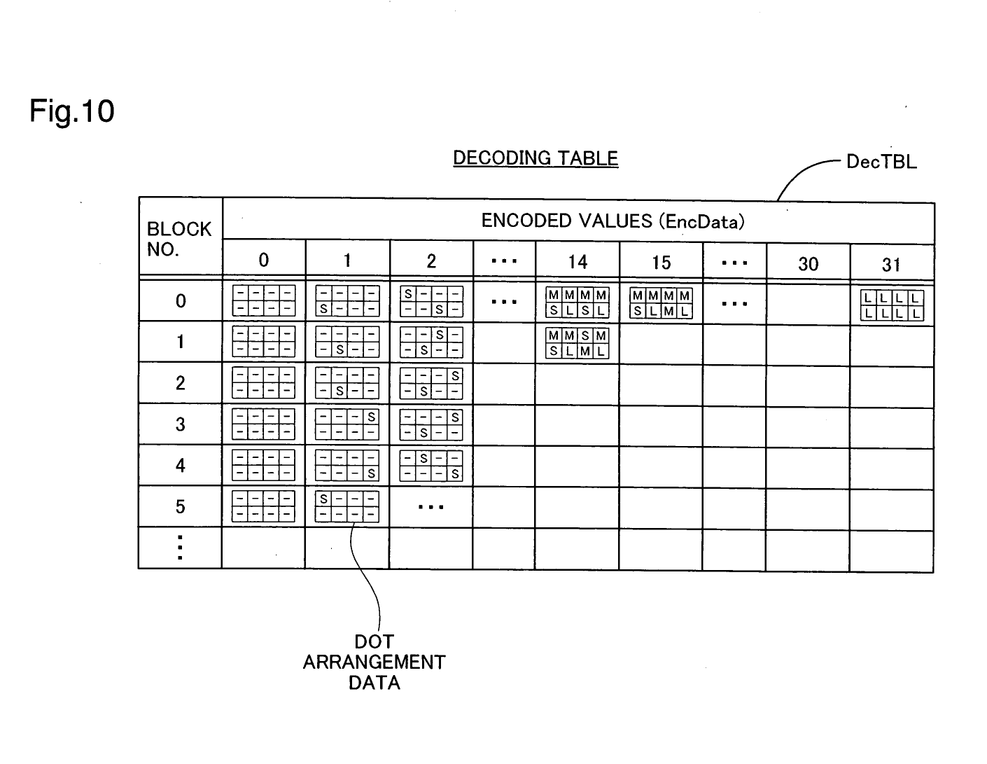

FIG. 10 is an explanatory drawing showing the data structure of the decoding table DecTBL. As shown in the drawing, block numbers and encoded values are correlated in this decoding table DecTBL, and dot arrangement data representing the type and position of dots arranged within the block is recorded. The decoding unit 420 shown in FIG. 4 is able to easily obtain the dot arrangement pattern to be formed on the printing medium by referencing this decoding table DecTBL based on the block number corresponding to the position of the pixel subject to processing and on the encoded value input from the intermediate buffer BF.

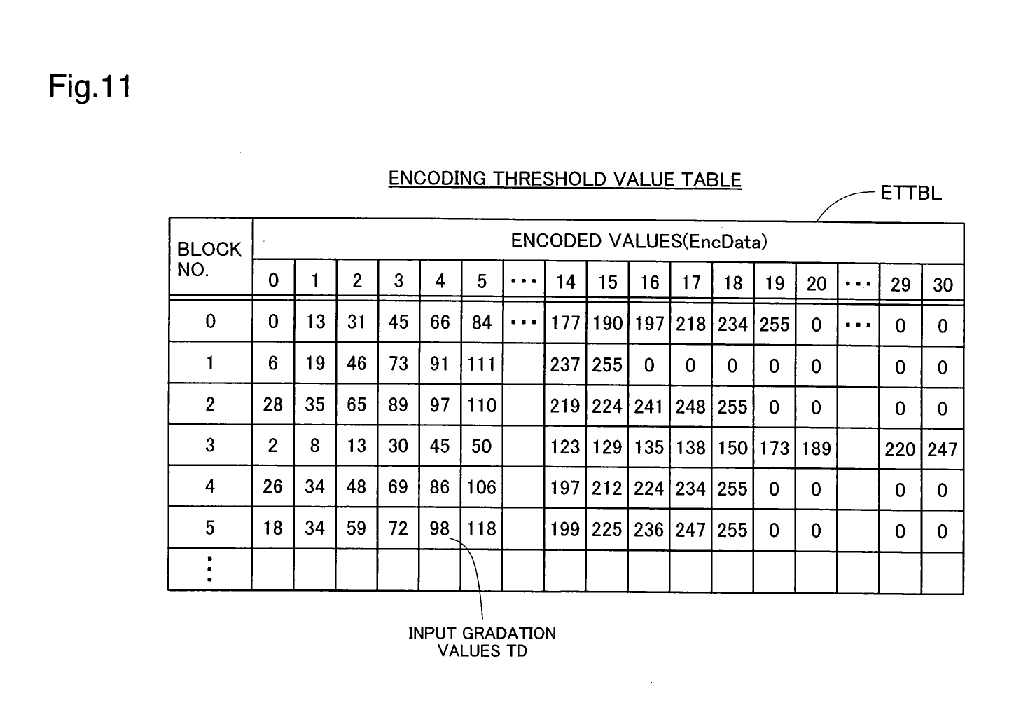

FIG. 11 is an explanatory drawing showing the data structure of the encoding threshold value table ETTBL. As shown in the drawing, the block numbers and encoded values are correlated, and values of the input gradation values TD representing values from 0 to 255 are recorded in this encoding threshold value table ETTBL. This encoding threshold value table ETTBL is data used only for generating the encoding table EncTBL described later, so it is not used for the halftone process by the halftone process unit 400. Because of that, here, the encoding threshold value table ETTBL itself will not be discussed.

The description returns to FIG. 7. When the CPU 151 generates the encoding threshold value table ETTBL and the decoding table DecTBL with the decoding table generating process of step S120, using the encoding threshold value table ETTBL generated with this process, it executes the encoding table generating process that performs generation of the encoding table EncTBL (step S130). Because this encoding table generating process is also a complex process, a detailed description will be given later. Here, we will describe the data structure of the encoding table EncTBL obtained as a result of the encoding table generating process.

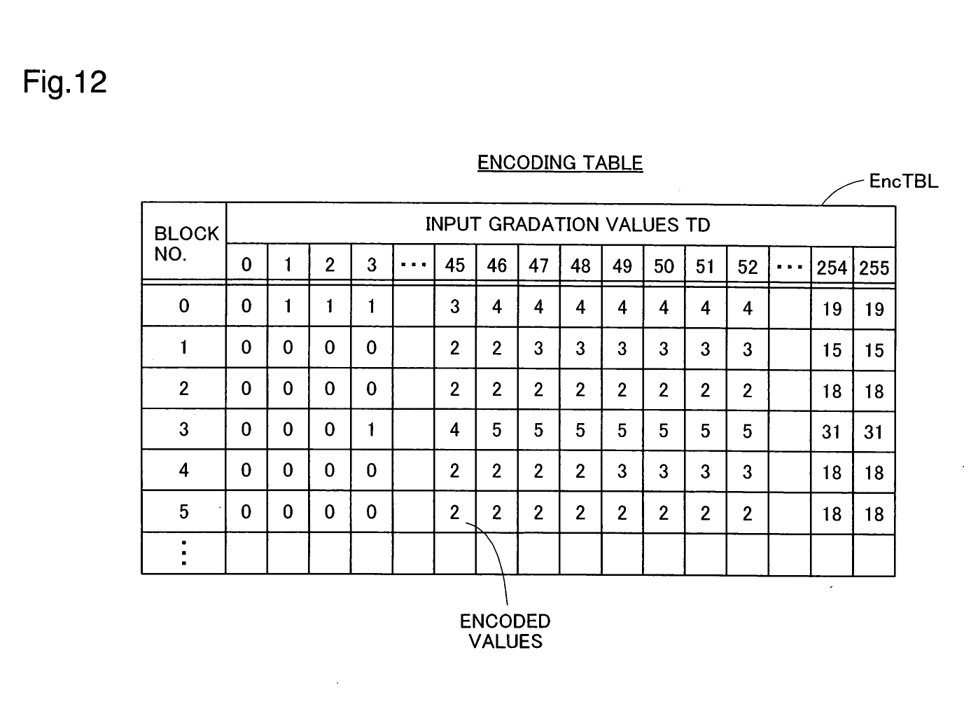

FIG. 12 is an explanatory drawing showing the data structure of the encoding table EncTBL. As shown in the drawing, the block numbers and CMY gradation values are correlated and encoded values represented by 5-bit values are recorded in this encoding table EncTBL.

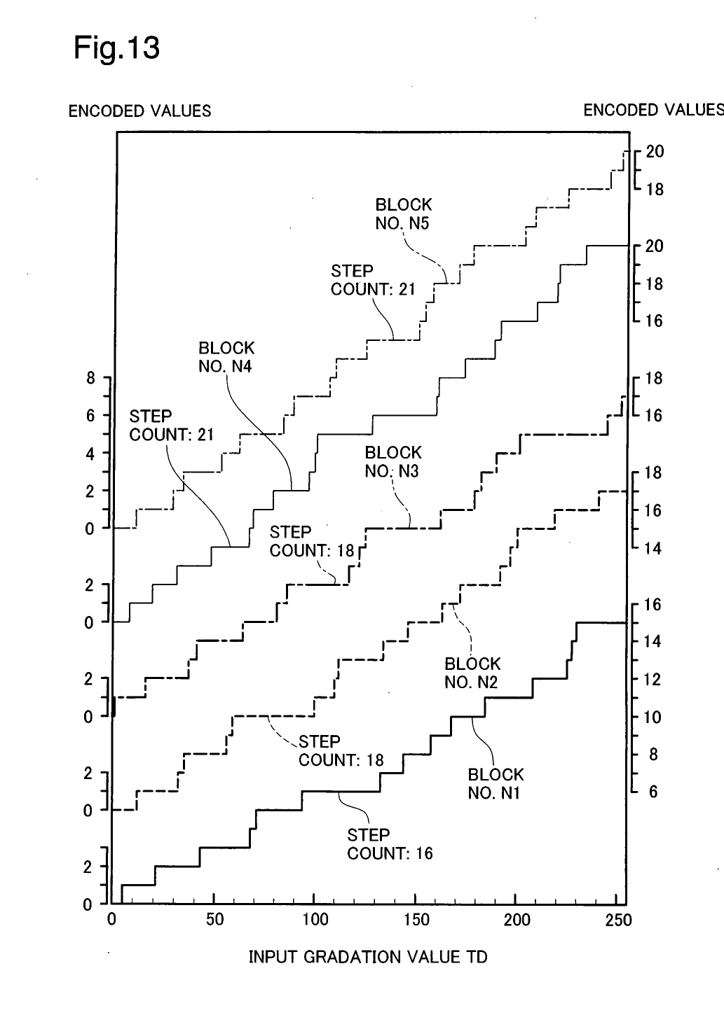

FIG. 13 is an explanatory drawing typically showing the change in the encoded values recorded in the encoding table EncTBL. FIG. 13 shows an example of the change in the encoded values according to the gradation values for the 5 blocks from block number N1 to N5. For convenience of illustration, the encoded value change is depicted with the vertical axis skewed for each block. As shown in the figure, for each block, if the gradation value increases, the value of the encoded value also increases, but that increase aspect is different for each block. The value of the encoded value for each block is a value showing the dot arrangement data in the decoding table DecTBL shown in FIG. 11. Because of that, in the CMY image, even for pixels having the same gradation values, if the pixel position is different, the applied block number is also different, and at the positions on the printing medium corresponding to those pixels, different dot arrangement data is formed.

The description returns to FIG. 7. With the process above, when the CPU 151 generates the decoding table DecTBL and the encoding table EncTBL, these tables are stored in the RAM 152 (step S140). In this way, the encoding table EncTBL and the decoding table DecTBL stored in the RAM 152 are used for the encoding process and the decoding process at the halftone process unit 400 shown in FIG. 4. Note that for the encoding threshold value table ETTBL generated with the decoding table generating process, this will not be used for the encoding process or the decoding process, so it is also possible to erase it from the RAM 152 after generation of the encoding table EncTBL.

D. Decoding Table Generating Process:

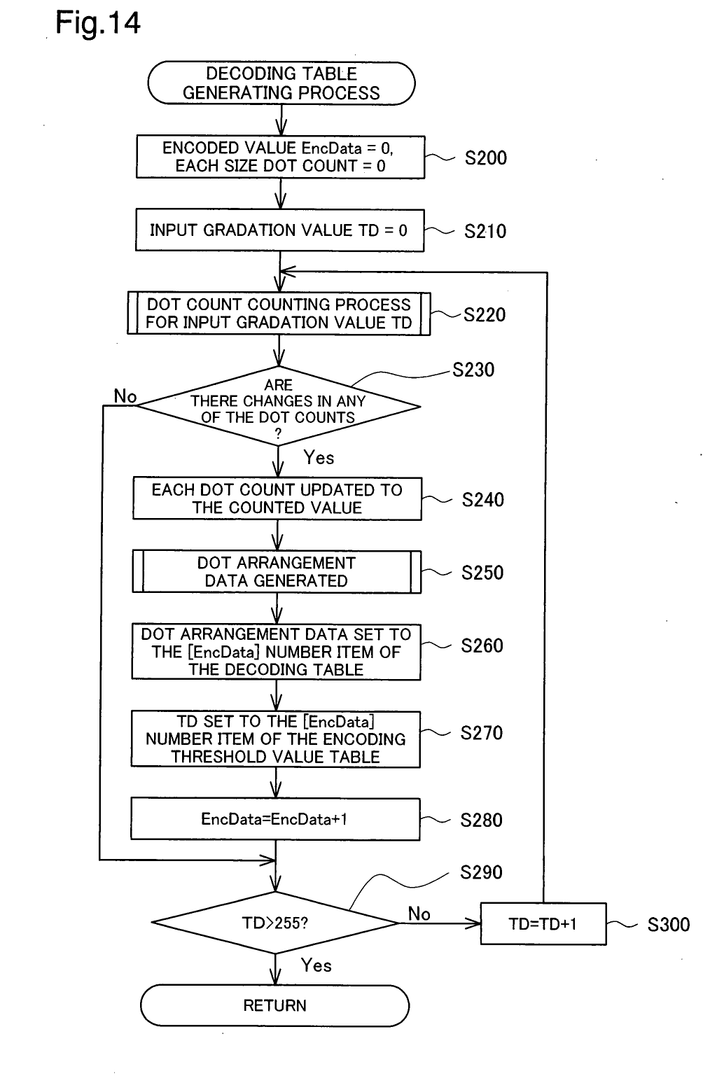

FIG. 14 is a flow chart showing the details of the decoding table generating process executed at step S120 of FIG. 7. This process is the process performed for each block on all the blocks (block numbers 1 to 4096) shown in FIG. 8.

When this process is executed, the CPU 151 first, as the variables used with the process hereafter, uses “0” for the encoded value EncData and uses “0” for the dot count of each size generated within the current block (step S200). Then, it further uses “0” as the input gradation value TD (step S210).

Next, the CPU 151 performs the dot count counting process that uniquely determines the dot count of each size generated within the current block according to the input gradation value TD set at the aforementioned step S210 (step S220).

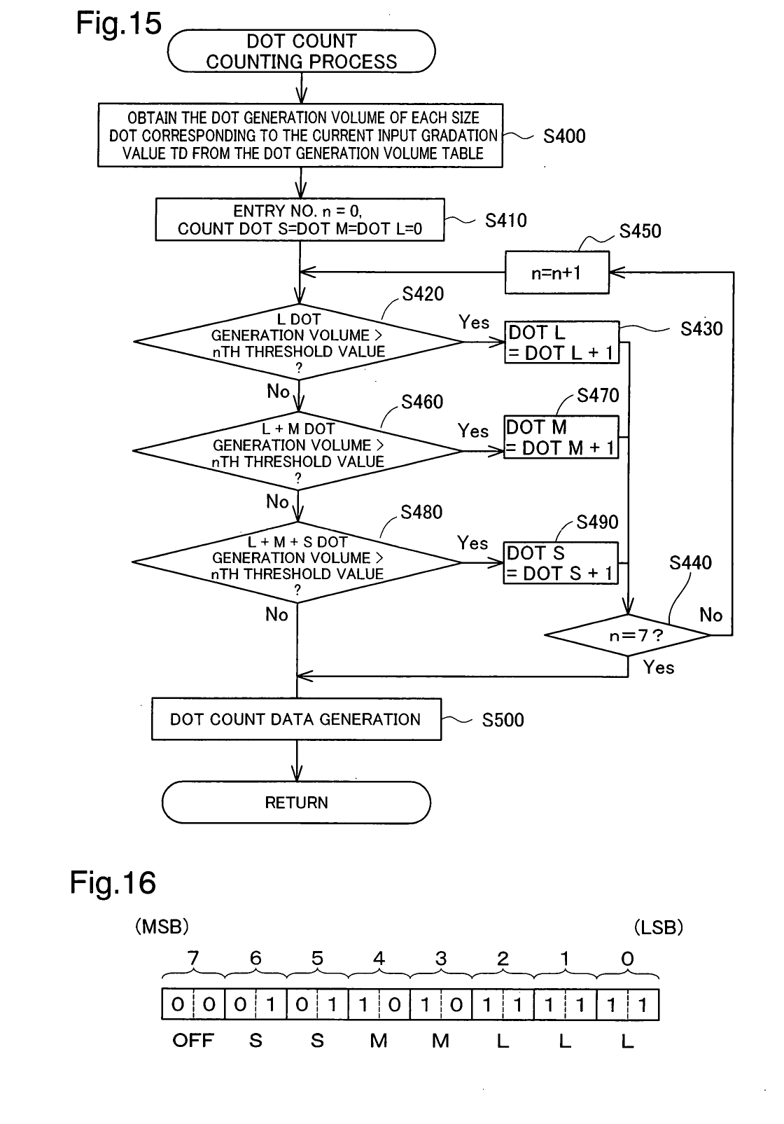

FIG. 15 is a flow chart showing the details of the dot count counting process at the aforementioned step S220. With this process, first, the CPU 151 obtains the generation volume of each size dot corresponding to the input gradation value TD set at the aforementioned step S210 from the dot generating volume table DGTBL (see FIG. 9) (step S400).

When the generation volume of each size dot is obtained, the CPU 151 reads the dither data DthDAT having a threshold value that is sorted corresponding to the current block number (see FIG. 8(d)) from the RAM 152. Then, with the entry number n referenced within that dither data DthDAT as “0,” and also the count (dot L, dot M, dot S) of each size dot as “0,” initialization is done (step S410).

When the entry number n and the count number are set, the CPU 151 reads the threshold value corresponding to the current entry number n from the dither data DthDAT. Then, a determination is made of whether or not the dot generation volume of the L dots obtained at the aforementioned step S400 is greater than this threshold value (step S420). As a result of this determination, if the L dot generation volume is greater than the entry number n threshold value (specifically, the nth threshold value) (step S420: Yes), then the L dot count number dot L is incremented (step S430). Specifically, in this case, the L dot count generated within the 4×2 dot arrangement data is increased by 1.

When the L dot count number dot L is incremented, the CPU 151 determines whether or not the current entry number n is “7” (step S440). As a result, if the entry number n is “7,” all the threshold values within the dither data DthDAT are referenced, and it is possible to determine that the counting of the dot count has ended, so the process advances to step S500 described later. Meanwhile, at step S440, if the entry number n is not “7,” to continue the comparison of the next entry number threshold value and the dot generation volume, the entry number n is incremented (step S450), and the process returns to the aforementioned step S420.

At the aforementioned step S420, if the L dot generation volume is the nth threshold value or less (step S420: No), the CPU 151 next determines whether or not the cumulative volume of the M size and L size dot generation volumes obtained from the dot generating volume table DGTBL exceeds the nth threshold value (step S460). As a result, when the cumulative volume of the M size and L size dots is determined to be greater than the nth threshold value (step S460: Yes), the M dot count dot M is incremented (step S470). Specifically, in this case, the M dot count arranged within the 4×2 dot arrangement data increases by 1.

When the M dot count dot M is incremented, the CPU 151 moves the process to the aforementioned step S440. By doing this, when the entry number n has not reached “7,” the entry number n is incremented (step S450), the process is returned to the aforementioned step S420.

At the aforementioned step S460, if the cumulative volume of the dot generation volume of the M dots and L dots is determined to be the nth threshold value or less (step S460: No), next, the CPU 151 determines whether or not the cumulative volume of the dot generation volume of the S dots, M dots, and L dots obtained from the dot generation volume table DGTBL exceeds the nth threshold value (step S480), and as a result, if the cumulative volume of this dot generating volume is determined to be greater than the nth threshold value (step S480: Yes), the S dot count dot S is incremented (step S490). Specifically, in this case, the S dot count arranged within the 4×2 dot arrangement data is increased by 1.

When the S dot count is incremented, the CPU 151 moves the process to the step S440 described above. By doing this, when the entry number n has not reached “7,” the entry number n is incremented by 1 (step S450), and the process is returned to the aforementioned step S420.

At the aforementioned step S480, when the cumulative volume of the dot generation volume of the S dots, M dots, and L dots is determined to be the nth threshold value or less (step S480: No), if, at the aforementioned step S440, it is determined that referencing has been done to the 8th threshold value, (step S440: Yes), the CPU 151 finally generates the dot count data DCDAT that records the count of each dot size (step S500).

FIG. 16 is an explanatory drawing showing an example of the dot count data DCDAT. In the drawing, represented is dot count data when 3 L dots, 2 M dots, and 2 S dots are arranged within the 4×2 dot arrangement data. As shown in the drawing, this dot count data DCDAT has a data volume of 16 bits, and the data representing the dot type is represented using a 2-bit dot size value with “11” for the L dots, “10” for the M dots, “01” for the S dots, and “00” for no dots. Recording of the dot size values is done so that the for this dot count data DCDAT, the more a dot size value represents a larger size dot, the more it is positioned at the lower bit side (LSB side).

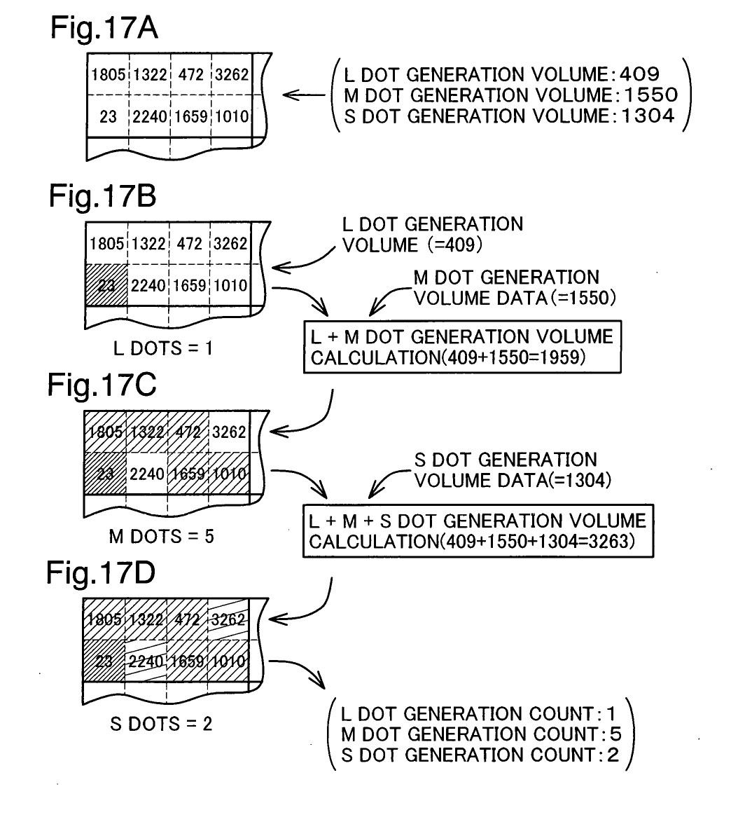

FIG. 17 is an explanatory drawing showing a specific example of the dot count counting process described above. As shown in FIG. 17(a), here, for the dot generating volume table DGTBL, with the L dot's dot generation volume corresponding to the current input gradation value TD as “409,” the M dot as “1550,” and the S dot as “1304,” the dither data DthDAT corresponding to the current block is the dither data shown in FIG. 8(d).

In this case, first, at step S420 in FIG. 15, the first threshold value “23” within the dither data DthDAT and the dot generation volume “409” of the L dot are compared. When this is done, this dot generation volume “409” is greater than the threshold value “23,” so a judgment of “Yes” is made at step S420, and the L dot count is incremented at step S430 to become “1.” By doing this, with step S450, the entry number n is incremented, so at the subsequent step S420, a comparison is done of the 2nd threshold value “472” and the dot generation volume of the L dot “409.” In this case, the dot generation volume “409” is smaller than the threshold value “472,” so at step S420, a judgment of “No” is made, and the process advances to step S460. At this point in time, the L dot count is set as “1” as shown in FIG. 17(b).

At step S460, a comparison is done of the cumulative value of the L dot's dot generation volume and the M dot's dot generation volume “1959 (=409+1550)” and the 2nd threshold value “472.” As a result, since the cumulative value “1959” of the dot generation of the L dots and the M dots is greater than the threshold value “472,” a judgment of “Yes” is made at step S460, the M dot count is incremented at step S470 to become “1.” By doing this, there is a further referencing of the next threshold value “1010.” However, in this case as well, the cumulative value of the dot generation volume “1959” is still greater than the threshold value “1010,” so in the end, the M size count is incremented until the 7th threshold value “2240” is referenced. As a result, the M size count is set at “5” as shown in FIG. 17(c).

When the 7th threshold value “2240” is referenced, a judgment of “No” is made at step S460, so next, at step S480, the cumulative value of the dot generation volume of the L dots, the M dots, and the S dots “3263 (=409+1550+1304)” is compared with the 7th threshold value “2240.” As a result, because the dot generation volume cumulative value “3263” is greater than the 7th threshold value, a judgment of “Yes” is made at step S480, and the S dot count is incremented at step S490 to become “1.” When this is done, next, the 8th threshold value “3262” is referenced.

The cumulative value of the dot generation volume of the L dots, M dots, and S dots “3263” remains greater than the 8th threshold value “3262.” Because of this, at step S480, a judgment of “Yes” is again made, and at step S490, the S size dot count is incremented, and becomes “2” as shown in FIG. 17(d). By doing this, since the current entry number n is “7,” at step S440, a judgment of “Yes” is made, and the count of each size dot is set. Specifically, with the example shown above, there is 1 L dot, 5 M dots, and 2 S dots.

As described using FIG. 17 above, with the dot count counting process described above, first, the L dot generation count is determined, and then, the M size and S size dot generation counts are determined. When determining the generation count of each size, a comparison is done with the threshold value while adding the generation volume of each size dot, so finally, as shown in FIG. 17(d), the dots of each size are arranged within the block in sequence from the L dots without being superimposed.

Note that with FIG. 17, it appears that the arrangement of each dot is determined within the block, but in actuality, with this dot count counting process, the dots of each size are counted using only the threshold values sorted in ascending sequence, so determination is not made up to that arrangement. With the dot arrangement data generating process described later, the dot arrangement is determined by the number of dots counted by this process and by the sequence value within the dither data DthDAT.

Here, we will examine another specific example of the dot count counting process. For example, the dot generation volume for both the L dots and M dots corresponding to the current input gradation value TD is “0,” and the dot generation volume for the S dots is “1500.” Also, the dither data DthDAT corresponding to the current block is the dither data shown in FIG. 8(d). By doing this, at step S420 and step S460 of the flow chart shown in FIG. 15, the L dot generation volume and the M dot generation volume are both “0,” which is smaller than the 1st threshold value “23,” so a judgment of “No” is made, and the process advances to step S480. Then, with this step S480, at the point in time when the 5th threshold value “1659” that exceeds the dot generation volume “1500” is referenced, at step S480, a judgment of “No” is made, the S dot count is set at “5,” and the counting process ends. Specifically, with this embodiment, the threshold values within the dither data DthDAT are sorted in ascending sequence and recorded, so at the point in time that the threshold value exceeding the cumulative volume of the dot generation volume of all sizes is referenced, it becomes unnecessary to reference the next threshold value. Therefore, the counting process of each size dot is accelerated, and thus, it is possible to perform high speed initialization processing.

Here, the description returns to step S230 in FIG. 14. When step S220 of FIG. 14, specifically, the dot count counting process shown in FIG. 15 is executed and the dot count of each size is counted, next, the CPU 151 makes a determination of which of the dot counts of each size has changed with the input gradation value TD this time in relation to the dot count of each size for the previous input gradation value TD (step S230). For example, with the previous counting process, when there are 2 S dots, 5 M dots, and 1 L dot, with the current counting process, if there are 2 S dots, 4 M dots, and 2 L dots, then the count of the M dots and the L dots have changed, so with the aforementioned step S230, a judgment of changed (Yes) is made.

At the aforementioned step S230, if a judgment is made that there is a change (step S230: Yes), the dot count of each size corresponding to the current block number and encoding value EncData is updated to the value counted with the aforementioned step S220 (step S240). Then, dot arrangement data is generated (step S250) based on the dot count data DCDAT generated at the aforementioned counting process step S500 and on the sequence values within the dither data DthDAT. Note that the details of this dot arrangement data generation process are described later.

When the dot arrangement data is generated at the aforementioned step S250, the CPU 151 records the dot arrangement data generated at step S250 at the locations corresponding to the current block number and the encoded value EncData within the decoding table DecTBL of FIG. 11 (step S260). Then furthermore, the current input gradation value TD is recorded at the locations corresponding to the current block number and encoded value within the encoding threshold value table ETTBL shown in FIG. 11 (step S270). With these processes, the encoding threshold value table ETTBL and the decoding table DecTBL are generated.

When the recording of the dot arrangement to the decoding table DecTBL and the recording of the input gradation value TD to the encoding threshold value table ETTBL are completed, the CPU 151 increments the current encoding value EncData (step S280). Specifically, with this step S280, the encoded value EncData is changed each time the count of any of the size dots changes at the aforementioned step S230. To say this another way, the encoded value EncData changes with each change of the contents of the 4×2 dot arrangement data.

With the aforementioned step S280, after the encoded value EncData is incremented, if it is judged that there is no change for any of the size counts at the aforementioned step S230, the CPU 151 determines whether or not the current input gradation value TD exceeds “255” (step S290). As a result, if the input gradation value TD does not exceed “255” (step S290: No), after incrementing the current input gradation value TD (step S300), the process is returned to the aforementioned step S220. On the other hand, if the current input gradation value TD does exceed “255” (step S290: Yes), the decoding table generating process ends, and the process moves to the step S130 in FIG. 7 (process of generating the encoding table).

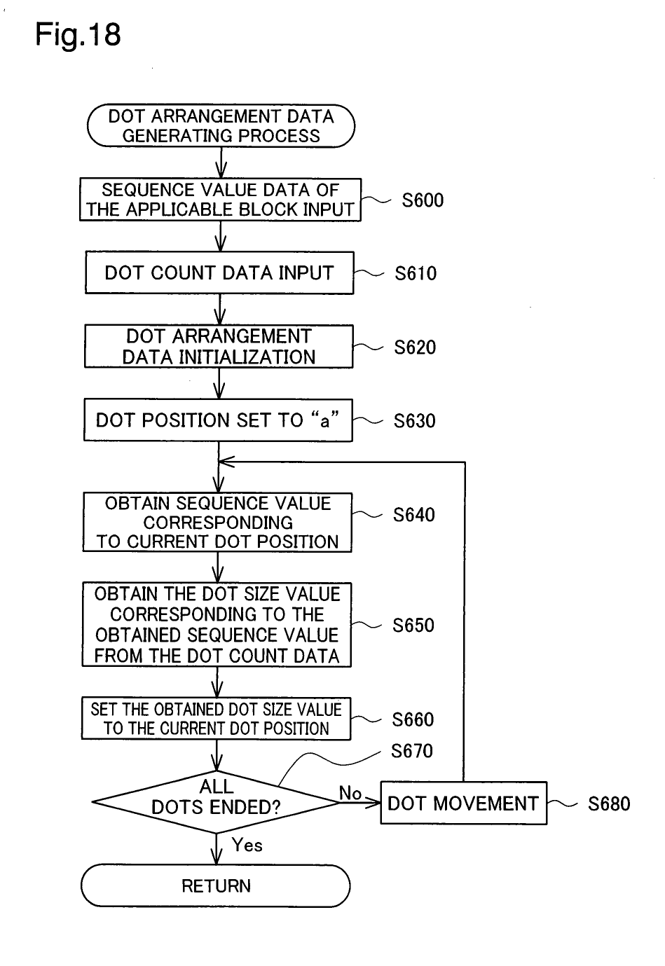

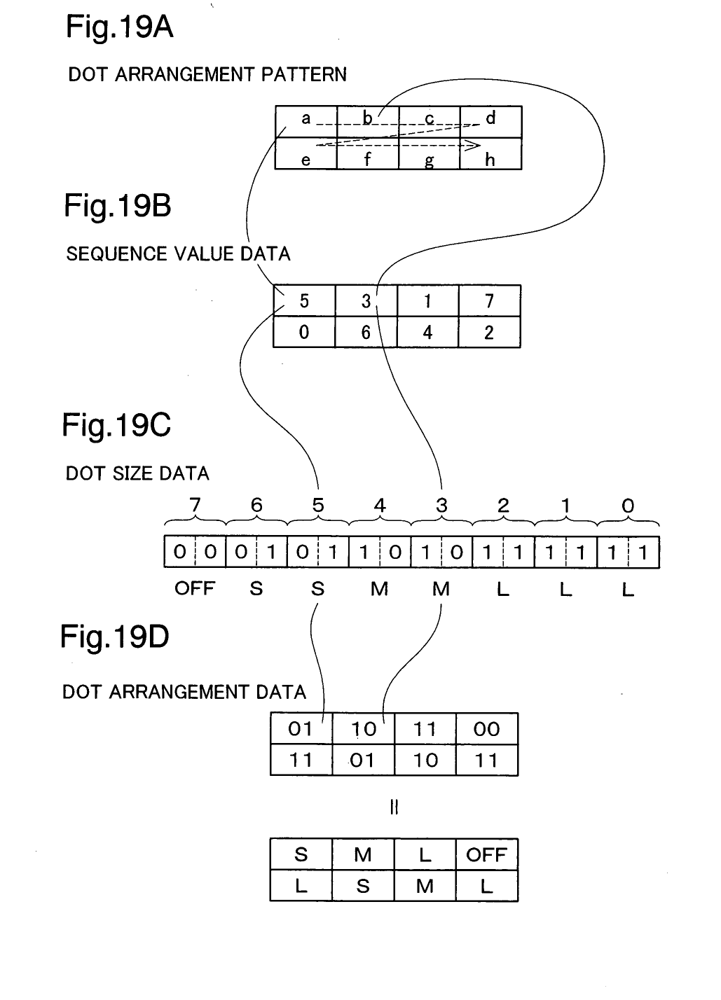

Here, a detailed description is given of the dot arrangement data generating process executed at step S250 of the decoding table generating process described above while referring to FIG. 18 and FIG. 19.

FIG. 18 is a detailed flow chart of the dot arrangement data generating process. Meanwhile, FIG. 19 is an explanatory drawing typically representing the processes of generating the dot arrangement data. In FIG. 18, when the dot arrangement data generating process is executed, the CPU 151 first references the dither data DthDAT corresponding to the current block number (see FIG. 8(d)), and inputs the sequence value data (step S600). Then, it inputs the dot count data DCDAT (step S610) (see FIG. 16) generated at step S500.

Next, the CPU 151 performs initialization by recording the dot size value “00” representing “no dots” for all the elements of the 4×2 dot arrangement data to be generated from now (step S620). Then, the position on the dot arrangement data at which dots are to be arranged from now are set to the position “a” (position farthest to the upper left) shown in FIG. 19(a) (step S630).

When the position at which the dots are to be arranged from now is set, the CPU 151 obtains the sequence value corresponding to the current dot position from the sequence value data (step S640). An example of the sequence value data input from the dither data DthDAT is shown in FIG. 19(b). With the example shown in the drawing, the sequence value corresponding to the current position “a” is “5,” so with the aforementioned step S640, this value “5” is obtained.

Next, the CPU 151 obtains from the dot count data DCDAT the dot size value corresponding to the sequence value obtained at step S640 (step S650). In specific terms, for every 2 bits from the lower bit side of the dot count data DCDAT, an amount of the value of the sequence value obtained at step S640 is counted, and the dot size value recorded at that position is obtained. FIG. 19(c) shows an example of the dot count data DCDAT input with the aforementioned step S610. In this drawing, the dot size value corresponding to the sequence value “5” is the dot size value “01” which is the sixth item counted from the lower bit of the dot size data. The dot size value “01” indicates that this is an S size dot.

When the dot size value is obtained, the CPU 151 sets the obtained dot size value at the current position on the dot arrangement data (step S660). Specifically, as shown in FIG. 19(d), if the current position is the “a” position, at that position, the dot size value “01” obtained from the dot count data DCDAT of FIG. 19(c) is set.

When the dot size value is set at the current position, the CPU 151 determines whether or not the setting of the dot size value has ended for all the positions (step S670). As a result, if the setting of the dot size value has ended for all the positions, then the concerned dot arrangement data generating process ends. On the other hand, if it has not ended, then by moving the dot arrangement data current position and returning the process to the aforementioned step S640, the dot size value is set for other positions.

With the dot arrangement data generating process described above and the dot count counting process described above, the following effects occur. Specifically, when a comparison is done of the dot arrangement data generating results shown in FIG. 19(d) and the 4×2 sequence value data shown in FIG. 19(b), we can see that arrangement is done in sequence from the large size dots to positions of low sequence value without any superimposition. The low sequence value means that the value of the threshold value within the threshold value group corresponding to that sequence value is low (see FIG. 8(b)). With the wide dither table WDTBL shown in FIG. 8(a), due to the nature of dither patterns with the ordered dither method, the threshold values are arranged with good dispersibility the lower the value is, and the higher the value is, that threshold value is arranged so as to avoid locations of already arranged threshold values. Specifically, with the dot arrangement data shown in FIG. 19(d), because arrangement is done with the priority from the dots of the largest size at the location of the low sequence value, specifically the low threshold value, the larger the size of the dot, the better dispersibility the arrangement is done with. Therefore, with the dot arrangement method of this embodiment, it is possible to maximize the dispersibility of the large dots that stand out on the printing paper, so it is possible to greatly improve the image quality of the output image.

Above, we described the details of the decoding table generating process shown in step S120 of FIG. 7. The CPU 151 is able to generate the decoding table DecTBL shown in FIG. 10 by executing this decoding table generating process on all the blocks shown in FIG. 8.

E. Encoding Table Generating Process:

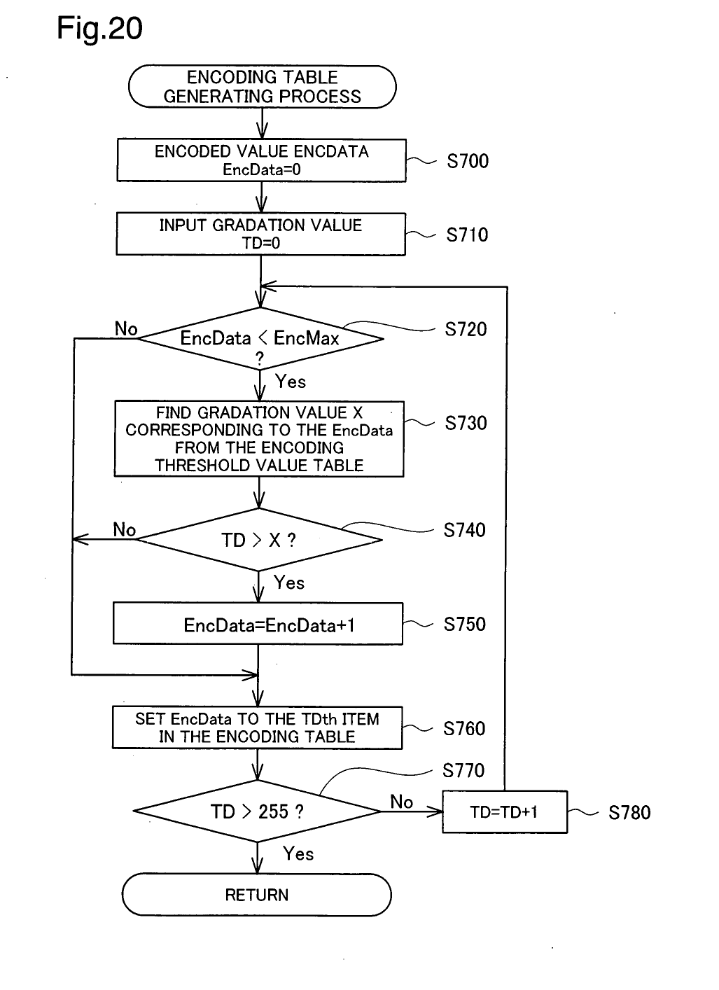

FIG. 20 is a detailed flow chart of the encoding table generating process at step S130 of the initialization process shown in FIG. 7. This process is a process for referencing the encoding threshold value table ETTBL shown in FIG. 11 and generating the encoding table EncTBL shown in FIG. 12. This encoding table generating process is the same as the decoding table generating process described above, and is a process performed with each block for all the blocks shown in FIG. 8.

When this process is executed, first, the CPU 151 uses “0” as the current encoded value EncData (step S700) and “0” as the current input gradation value TD (step S710) as the variables used with the process thereafter.

Next, the CPU 151 determines whether or not the current encoded value EncData is less than the maximum encoded value EncMax (step S720). The maximum value EncMax is “31” when the encoded value is 5-bit data.

At the aforementioned step S720, when it is determined that the current encoded value EncData is less than the maximum value EncMax (step S720: Yes), the CPU 151 references the encoding threshold value table ETTBL (see FIG. 11) generated by the aforementioned decoding table generating process (see FIG. 14), and obtains the input gradation value X corresponding to the current encoded value EncData (step S730). As a result, the current input gradation value TD determines whether or not the input gradation value X obtained at step S730 exceeds the input gradation value X (step S740), and if the input gradation value TD value does exceed the input gradation value X (step S740: Yes), the current encoded value EncData is incremented (step S750).

The CPU 151, after the encoded value EncData is incremented at the aforementioned step S750, or, when the encode value EncData is the maximum value EncMax or greater at the aforementioned step S720 (step S720: No), or, when it is determined that the input gradation value TD does not exceed the input gradation value X at the aforementioned step S740 (step S740: No), the encoded value EncData is set for the element corresponding to the current block and the current input gradation value TD in the encoding table EncTBL shown in FIG. 12 (step S760).

Then, the CPU 151 determines whether or not the current input gradation value TD exceeds “255” which is the maximum value (step S770), and if it does exceed it (step S770: Yes), then the concerned encoding table generation process ends. On the other hand, if it does not exceed it (step S770: No), then the current input gradation value TD is incremented, and the process returns to the aforementioned step S720.

With the encoding table generating process described above, it is possible to generate the encoding table EncTBL shown in FIG. 12. With the encoding table generating process described above, while gradually adding input gradation values TD from 0 to 255, when the current input gradation value TD exceeds each input gradation value X recorded in the encoding threshold value table ETTBL, the value of the encoded value EncData is incremented. Because of this, with the encoding table EncTBL of FIG. 12, as the input gradation value TD gradually increases, the value of the encoded value EncData increases in steps as shown in FIG. 12 and FIG. 13.

Above, the description up to step S130 of the initialization process shown in FIG. 7 ended. When step S130 of this FIG. 7 ends, the CPU 151 stores the decoding table DecTBL generated at step S120 and the encoding table EncTBL generated at step S130 in the RAM 152. By doing this, the initialization process shown in FIG. 7 ends.

F. Halftone Process:

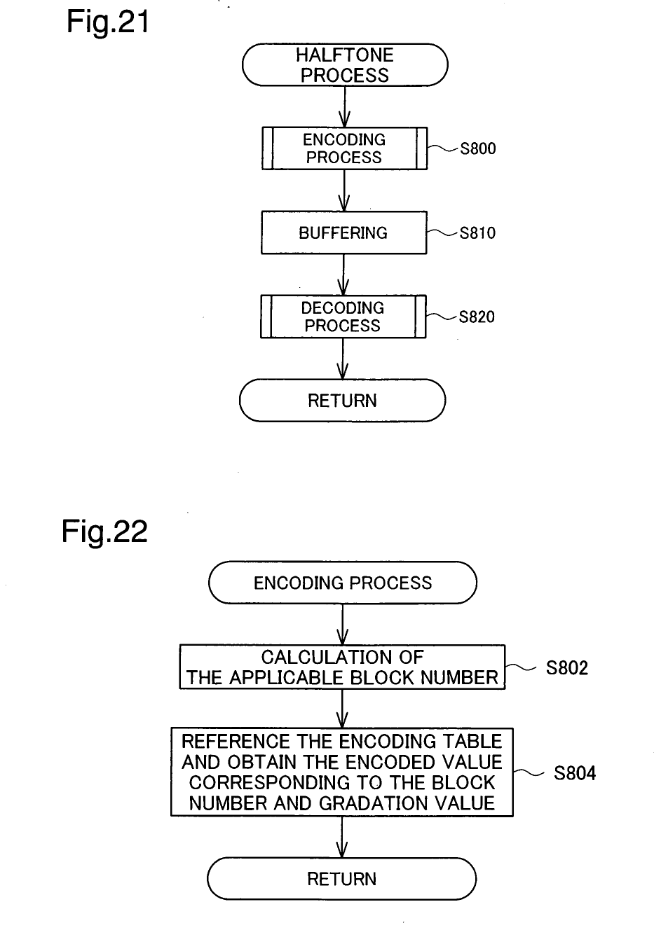

FIG. 21 is a detailed flow chart of the halftone process executed at step S40 of the printing process shown in FIG. 6. This halftone process is a process performed in 1 pixel units on the image data that was color converted from RGB format to CMY format by step S30 in FIG. 6.

When this halftone process is executed, the image processing ASIC 155 first uses the encoding unit 410 shown in FIG. 4 and performs the encoding process (step S800) that converts the gradation values of each color (C, M, Y, K, Lc, Lm) of the pixels subject to processing to encoded values EncData.

FIG. 22 is a flow chart representing the details of the encoding process executed by the encoding unit 410. When this encoding process is executed, the encoding unit 410 first performs calculation of the block number to which the pixel subject to processing belongs (step S802). Here, with this embodiment, the input resolution of the RGB image data subject to printing is 360 dpi×360 dpi, and the output resolution output to the printing paper is 1440 dpi×720 dpi. By doing this, 1 block size is 4×2, so with this kind of input resolution and output resolution relationship, 1 pixel of the input image corresponds to 4×2 dots of the output image. Specifically, with this embodiment, calculation of the block number is performed with 1 pixel of the CMY image subject to processing as an item corresponding to 1 block of the wide dither table WDTBL shown in FIG. 8.

A specific calculation method of the block number is described below. The wide dither table WDTBL shown in FIG. 8(a) has 32 blocks in the horizontal direction and 16 blocks in the vertical direction. Because of that, 1 piece of input image data is divided with 32 pixels×16 pixels as the unit, and calculation of the block number is performed so as to allocate a block number from 1 to 512 (=32×16) for each pixel within that unit. Specifically, with the coordinates of the current pixel for which to perform the encoding process as (X, Y), and the origin point as (0, 0), the Y coordinate of the current pixel is “0,” and with the X coordinate from “0” to “31,” the block number is allocated in sequence from “1” to “32.” After that, at the point in time when the X coordinate of the current pixel is “32,” the block number again becomes “1.” In this way, after block numbers from “1” to “32” are repeatedly applied in the image X direction, at the point in time when the current pixel coordinates are (0, 1), the block number becomes “33.” Then, after that, while the Y coordinate is “1,” block numbers from “33” to “64” are repeatedly allocated. In other words, the block number Num can be obtained using the formula (1) noted below when the coordinates of the pixel subject to the encoding process are (X, Y). However, in the formula (1) noted below, “%” is an operator for finding the remainder.
Num=((X% 32)+Y% 16)*32)+1 (1)

With the aforementioned step S802, when the block number calculation is performed, the encoding unit 410 references the encoding table EncTBL shown in FIG. 12, and from the current pixel gradation value TD and the block number Num calculated with step S802, obtains the corresponding encoded value EncData (step S804). For example, according to FIG. 12, if the current pixel gradation value is “48” and the calculated block number is “4,” the encoded value is obtained as “5.” With the process above, the encoding process by the encoding unit 410 ends.

Here, the description returns to FIG. 21. When the encoding process by the encoding unit 410 ends, the image processing ASIC 155 records the encoded value EncData obtained as a result of this encoding process in the intermediate buffer BF (see FIG. 4) prepared on the RAM 152 (steps S810a to S810f).

When the encoded value EncData is recorded in the intermediate buffer BF, the image processing ASIC 155 uses the decoding unit 420 to execute the decoding process that converts the encoded value EncData recorded in the intermediate buffer BF to dot arrangement data (steps S820a to S820f).

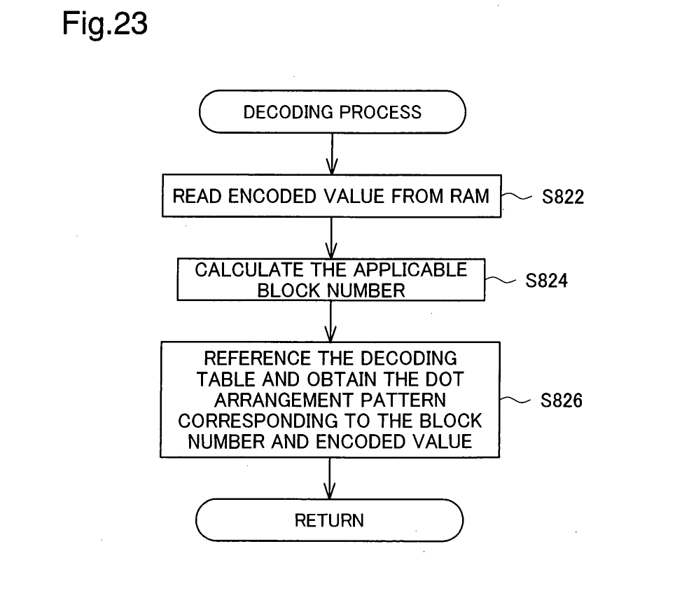

FIG. 23 is a detailed flow chart of the decoding process executed by the decoding unit 420. When this decoding process is executed, the decoding unit 420 first reads the encoded value EncData accumulated in the intermediate buffer BF (step S822).

After reading the encoded value EncData, the decoding unit 420 performs calculation of the block number to which the pixel subject to processing belongs (step S824). The calculation method for this is as described previously. Note that with this process, the decoding unit 420 can calculate the block number itself based on the calculation method described above, or it can also obtain the calculation results from the encoding unit 410.

When the block number calculation ends, the decoding unit 420 references the decoding table DecTBL shown in FIG. 10, and obtains the dot arrangement data (step S826) corresponding to the encoded value EncData read by step S822 and the block number calculated at step S824. With the process above, the decoding process by the decoding unit 420 and the series of halftone processes shown in FIG. 21 end.

With the halftone process of this embodiment described above, the halftone process on the CMY image is completed simply by referencing the two tables of the encoding table EncTBL and the decoding table DecTBL. Therefore, it is possible to realize a very fast halftone process. Also, from the decoding process and thereafter, even when time is required for the dot forming process by the printing mechanism, it is possible to do buffering of the encoded value EncData obtained as a result of the encoding process in the RAM 152, so it is possible to rapidly release the CPU 151 from the printing process. Also, the CMY image data having 8 bits (255 gradations) of data capacity for each color is reduced to data (encoded value) of 5 bits for each color by the encoding process, so it is possible to significantly reduce the storage capacity of the RAM 152, making it possible to reduce costs.

Note that with the embodiment described above, as shown in FIG. 6, described was an item for which the initialization process is executed each time the printing process is executed, but it is also possible to execute the initialization process using other timing. For example, it is also possible to execute when the power is turned on to the printer 100, or to execute when the printing paper or printing mode setting is changed by the user.

G. Effect:

With the printer 100 of this embodiment described above, the threshold values are sorted in ascending order and recorded within the dither data DthDAT which is the source for generating each table referenced with the halftone process. Therefore, with the process of counting the dot count generated within 1 block, referencing is done in sequence from the small threshold value, and at the point in time that a threshold value that exceeds the cumulative volume of the dot generation volume of all sizes is referenced, the counting process is completed, and it becomes unnecessary to reference the next threshold value. Therefore, the counting process of each size dot is accelerated, and thus, it is possible to perform the initialization process and the printing process at high speed. Also, it is possible to easily convert the image data to the dot arrangement pattern simply by referencing the encoding table and the decoding table generated based on this dither data DthDAT, so the process is simplified, and it is possible to perform the halftone process at high speed.

Also, with this embodiment, for the dither data DthDAT for which the basic purpose is to record only the threshold value, the remainder bit part is used to record the sequence value. Therefore, it is not necessary to separately manage the threshold value data used during generation of each table and the sequence value data used during generation of the dot arrangement data, so it is possible to efficiently perform management of the data stored in the RAM 152 and the ROM 153.

H. Modification

Above, we described an embodiment of the present invention, but the present invention is not limited to this kind of embodiment, and it goes without saying that it is possible to use various constitutions that do not stray from the scope of the key points. For example, it is possible to realize with software the function realized with hardware by the image processing ASIC 155 by executing a specified program using the CPU 151. In addition, the kinds of variations below are also possible.

(H1) First Modification:

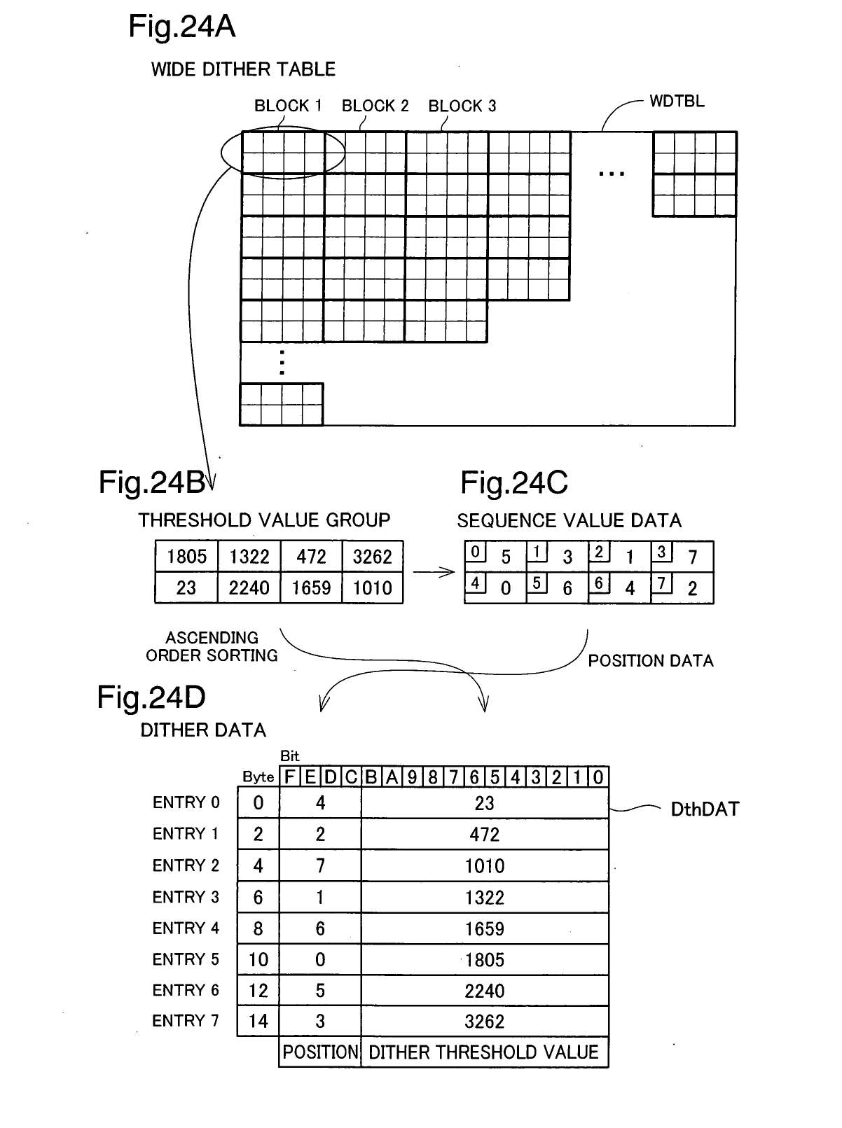

With the embodiment described above, as shown in FIG. 8(d), the sequence values were recorded in the upper 4 bits of the dither data DthDAT. As shown by the arrow in FIG. 8(c), these sequence values are recorded in sequence with 4×2 sequence values within 1 block positioned from the upper left to the lower right. In contrast to this, with this modification, as shown in FIG. 24, position data is recorded instead of the sequence values.

FIG. 24 is an explanatory drawing showing a modification of the dither data. With this modification, as shown in FIG. 24(c), for each of the 4×2 elements of the sequence value data, position data representing the position of the element was allocated. The numerical value shown in the frame surrounded by the four corners at the upper left of each sequence value is the position data. With this modification, the position data corresponding to that sequence value is recorded in sequence from the small sequence value in the upper 4 bits of the dither data DthDAT. For example, in FIG. 24(c), the lowest value of the sequence values is “0,” and the position data corresponding to this sequence value “0” is “4” in the farthest lower left in FIG. 24(c), so this “4” value is recorded at the first entry within the dither data DthDAT. Also, the next lowest sequence value is “1,” so the position data corresponding to this “1” is “2,” and this “2” value is recorded at the 2nd entry within the dither data DthDAT.

When considering a case of generating dot arrangement data using the dither data DthDAT with this modification, at step S640 in FIG. 18, when obtaining the sequence value corresponding to the current dot position, for example if the current dot position is “0,” the position data having this “0” value is searched for from within the dither data DthDAT. By doing this, the number entry at which that “0” value is recorded represents that sequence value. Therefore, with this modification, it is easy to obtain the sequence value.

Also, as described above, if the position data corresponding to the sequence value is recorded within the dither data DthDAT, then the position data and threshold value recorded in each entry as a result indicates the value of the same position within the block. Because of that, it is possible to easily perform handling and management of the dither data DthDAT.

(H2) Second Modification:

With the embodiment described above, with the processes of the decoding table generating process, when generating the dot arrangement data corresponding to each-block and each encoded value, because the dot granularity decreases, the arrangement is performed in sequence from the large size dots in the locations of low threshold values within the block. Because of that, within the decoding table DecTBL, the dot arrangement data correlated to the low gradation values (specifically, the encoded values) are mostly constituted from only small dots, so there are items with low dot dispersibility. In light of this, during the dot arrangement data generating process of FIG. 18, when dot arrangement data for which there is the risk of having low dot dispersibility is generated, by referencing extension sequence value data prepared separately from the sequence value data within the dither data DthDAT of FIG. 8(d), it is possible to increase the dot dispersibility.

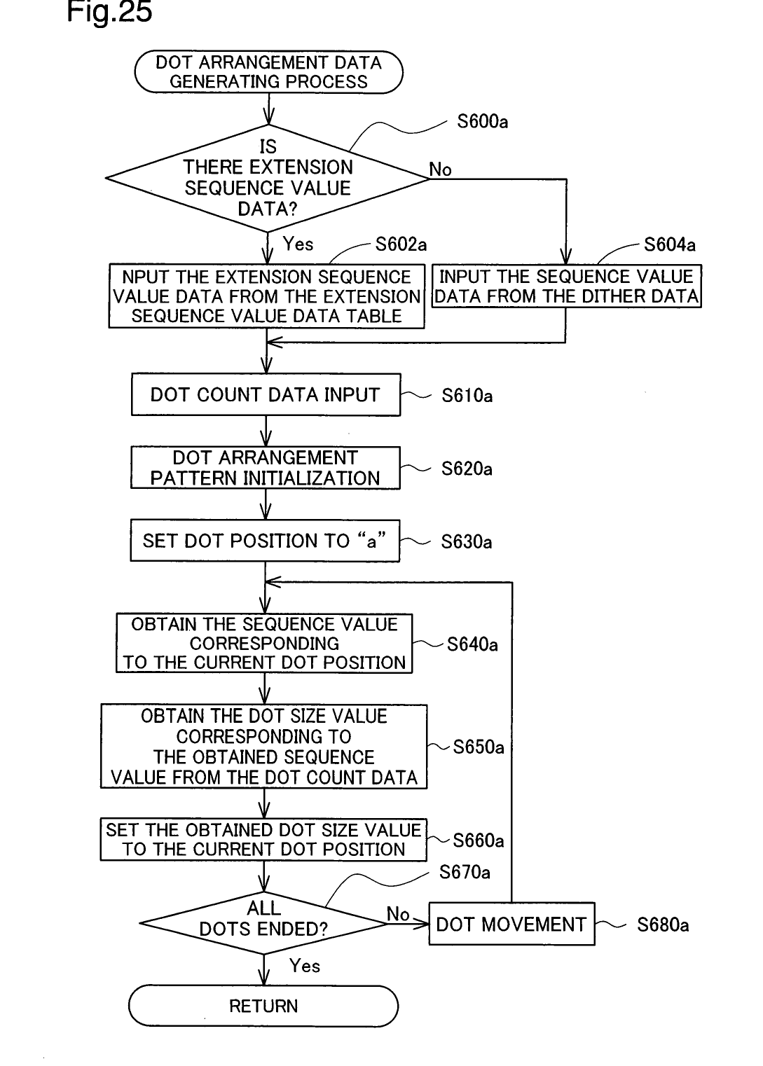

FIG. 25 is a flow chart of the dot arrangement data generating process for this modification. With the dot arrangement data generating process shown in FIG. 25, the process from step S610a to step S680a is exactly the same as the process from step S610 to step S680 of the dot arrangement data generation process shown in FIG. 18. Specifically, the different parts are step S600a, step S602a, and step S604a.

When this dot arrangement data generating process is executed, first, the CPU 151 determines whether or not the extension sequence value data correlated to the currently processing block number and encoded value EncData exists within the extension sequence value data table XTBL in the ROM 153 (step S600a).

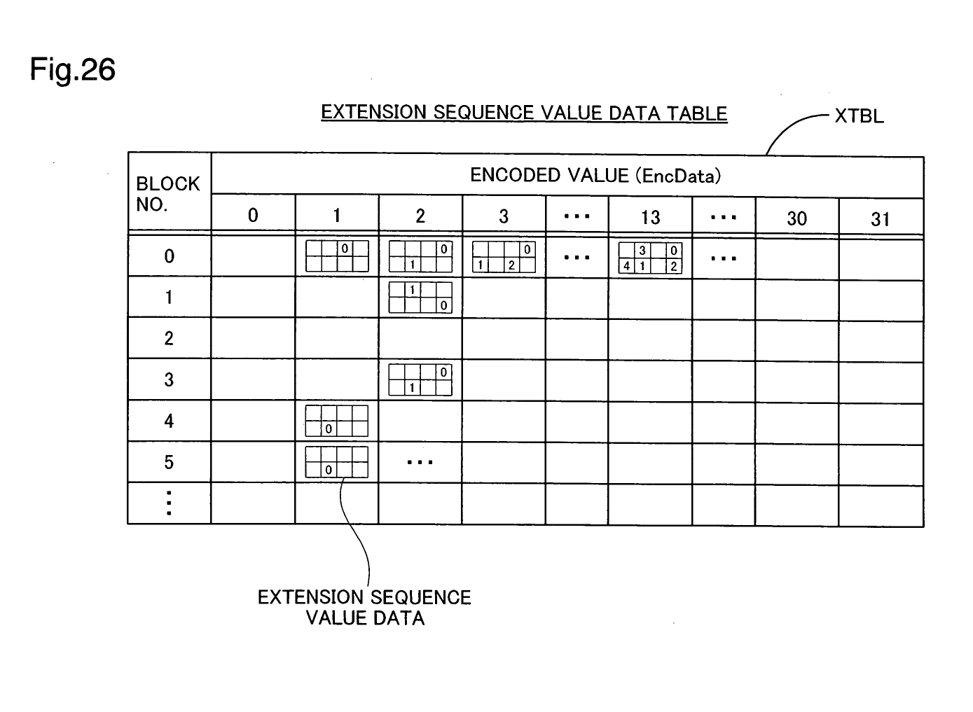

FIG. 26 is an explanatory drawing showing an example of the extension sequence value data table XTBL. As shown in the drawing, in this extension sequence value data table XTBL, the block numbers and encoded values are correlated and the extension sequence value data is stored. However, the extension sequence value data is not stored for all the blocks and all the encoded values. Specifically, storage is done only for block numbers and encoded values corresponding to dot arrangement data for which the dot dispersibility is low with application of normal sequence value data. Also, if the block numbers and encoded values are known, as a result, it is possible to understand in advance the number of dots generated within a block, and only the sequence values for the necessary count are set in the extension sequence value data. For example, in FIG. 26, for the extension sequence value data for which the block number is “1” and the encoded value is “13,” sequence values from 0 to 4 are set, but this is because we know in advance that the number of dots generated by this block number and encoded value is 5. In this way, by setting only the necessary sequence values, it is possible to significantly reduce the data capacity of the extension sequence value data table XTBL.

At the aforementioned step S600a, when it is judged that extension sequence value data correlated to the currently processing block number and encoded value EncData exists (step S600a: Yes), the CPU 151 inputs that extension sequence value data from the extension sequence value data table XTBL (step S602a). Meanwhile, when the extension sequence value data does not exist, the CPU 151 inputs normal sequence value data from the dither data DthDAT corresponding to the current block number (step S604a).

With the process above, when the extension sequence value data or the sequence value data is input, using the process of step 610a and thereafter, the CPU 151 generates the dot arrangement data as shown by the procedure shown in FIG. 19 while referencing the extension sequence value data or the sequence values within the sequence value data.

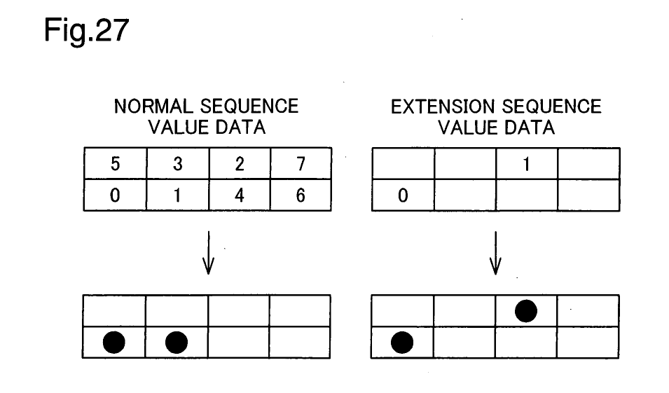

FIG. 27 is an explanatory drawing showing an example of the dot arrangement data when the extension sequence value data is applied and the dot arrangement data when it is not applied. This drawing shows an example of when two dots are arranged within one block. At the left side of the drawing are shown the results of dot arrangement according to normal sequence value data, and at the right side of the drawing are shown the results of dot arrangement with the extension sequence value data applied. As shown in the drawing, with the normal sequence value data, there are cases when dots are adjacent to each other and the dispersibility is very low, but with this modification, if the extension sequence value data is defined in advance, as shown at the right side of the drawing, it is possible to have the dots forcibly dispersed. In this way, with this modification, compared to the halftone process of the embodiment with the wide dither table WDTBL shown in FIG. 8(a) as the base, it is possible to perform printing with further improved image quality.

(H3) Third Modification:

With the embodiment described above, the decoding unit 420 of FIG. 4 is made to perform halftone processing by reading the encoded value EncData from the intermediate buffer BF and by obtaining the dot arrangement data corresponding to the encoded value EncData and the block number of the pixel subject to processing from the decoding table DecTBL.

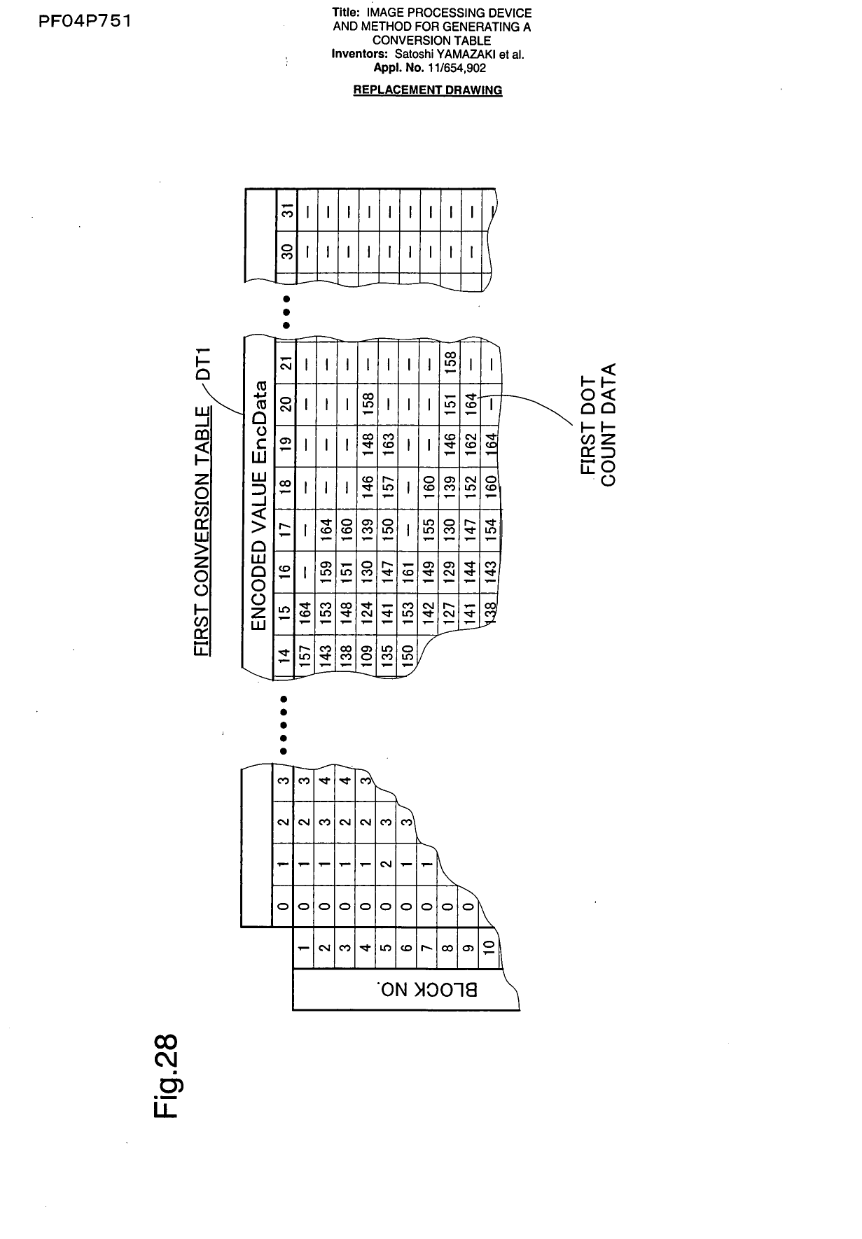

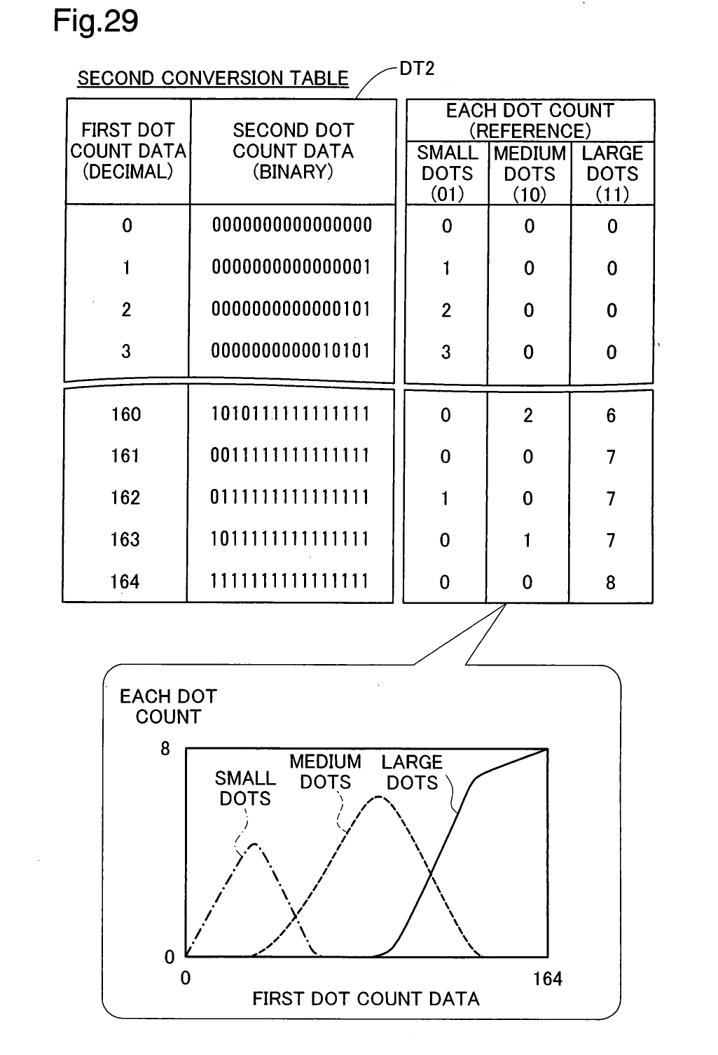

In contrast to this, with this modification, instead of the decoding table DecTBL in FIG. 10, decoding processing is realized using two conversion tables. FIG. 28 is an explanatory drawing showing an example of the first conversion table DT1 used with the decoding process of this modification. Also, FIG. 29 is an explanatory drawing showing an example of the second conversion table DT1 used with the decoding process of this modification.

In the first conversion table shown in FIG. 28 are recorded values ranging from 0 to 164 correlated to the block numbers and the encoded values (hereafter called “first dot count data”). This first dot count data are values that give a consolidated representation of the respective generation count of the L dots, M dots, and S dots. For the items for which the first dot count data is held in values up to 164, if we look at the 8 pixels constituting 1 block, for each pixel, we can have four states, including “large dots formed,” “medium dots formed,” “small dots formed,” and “no dots formed.” Therefore, for the combination of the dot counts, since the combination count becomes equal when these four states are selected 8 times allowing superimposition, it is possible to find this using ₄H₈ (=_{4+8[illegible symbol]1}C₈). From this, at the maximum, only 165 (0 to 164) combinations appear. Note that ₙHᵣ is an operator for finding the superimposed combinations when superimposition from within n items is allowed and selection is done r times. Also, ₙCᵣ is an operator for finding the combination count when superimposing from n items is not allowed and selection is done r times.

In the second conversion table shown in FIG. 29 are recorded second dot count data representing the dot count of each size correlated to the first dot count data shown in FIG. 28. This second dot count data correlates to the dot count data DCDAT of the embodiment described above. The same as with the embodiment, this second dot count data has dot size values representing the dot size recorded in sequence from the lower bits in large size sequence. For example, for the second conversion table DT2 of FIG. 29, if the first dot count data is “2,” then the second dot count data is “00, 00, 00, 00, 00, 00, 01, 01,” representing that 2 S dots are generated. At the right side of the second conversion table DT2 of FIG. 29, a breakdown of the dot count of each size represented by the second dot count data is shown. This second conversion table DT2 is a table generated based on the dot generating volume table shown at the bottom of the figure.

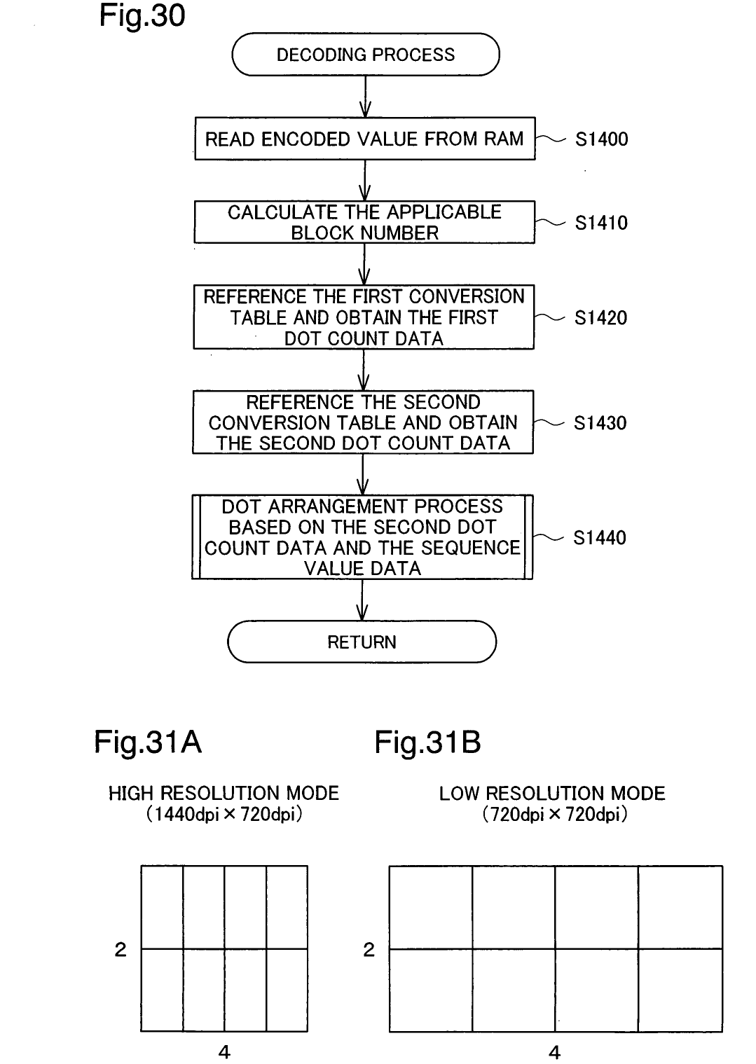

FIG. 30 is a flow chart of the decoding process executed by the decoding unit 420 of the image processing ASIC 155 with this modification. When this decoding process is executed, the decoding unit 420 first reads the encoded value EncData accumulated in the intermediate buffer BF (step S1400).

When the encoded value EncData is read, the decoding unit 420 performs calculation of the block number to which the pixel subject to processing belongs (step S1410). The method of this calculation is as described with the embodiment described above.

When calculation of the block number ends, the decoding unit 420 references the first conversion table shown in FIG. 28, and obtains the first dot count data corresponding to the encoded value EncData read with step S1400 and the block number calculated with step S1410 (step S1420).

When the first dot count data is obtained, next, the decoding unit 420 references the second conversion table shown in FIG. 29, and obtains the second dot count data corresponding to the first dot count data (step S1430).

When the second dot [count] data is obtained, the decoding unit 420 performs the process (step S1440) of arranging within the block each size dot defined in the second dot count data based on the sequence value data recorded in the dither data DthDAT corresponding to the second dot count data and the current block number obtained with step S1430. This arrangement process is the same process as the dot arrangement data generating process of FIG. 18 described with the embodiment. With the embodiment, this is a process for generating dot arrangement data recorded within the decoding table DecTBL, but with this modification, it is executed as a process of generating dot arrangement data dynamically according to the second dot count data. If this dot arrangement data generating process is executed, finally, the dot arrangement data corresponding to the block number and the encoded value is generated, and the decoding process of this modification ends.

With the third modification described above, by referencing two conversion tables, it is possible to convert the encoded value EncData obtained from the intermediate buffer BF to dot arrangement data. In the decoding table DecTBL shown in the embodiment, the 4×2 size dot arrangement data is correlated to all the block numbers and all the encoded values and stored, so the data capacity stored in the RAM 152 is relatively large. In contrast to this, with this modification, even when the data volume of the first conversion table DT1 and the data volume of the second conversion table DT2 are added, the total of that data capacity is lower than that of the decoding table of the embodiment. Therefore, it is possible to decrease the storage capacity of the RAM 152, and possible to reduce costs.

Note that the dot arrangement using the extension sequence value data for the second modification described above can also be applied to the third modification. Specifically, with the dot arrangement process of step S1440 of the decoding process shown in FIG. 30, by reading the extension sequence value data, it is possible to arrange the dots within the block based on this extension sequence value data. Therefore, with the third modification, it is possible to realize dot arrangement with higher dispersibility.

(H4) Fourth Modification:

With the embodiment described above, described was the halftone process when the input resolution is 360 dpi×360 dpi, and the output resolution is 1440 dpi×720 dpi (hereafter called the “high resolution mode”). In contrast to this, with this modification, described is the halftone process when the output resolution is reduced, with the input resolution at 360 dpi×360 dpi and the output resolution at 720 dpi×720 dpi (hereafter called the “low resolution mode”).

FIG. 31 is an explanatory drawing showing the difference in the actual size of the output of one block between the high resolution mode and the low resolution mode. In the drawing, shown relatively in (a) is the size of one block when in the high resolution mode and in (b) is the size of one block when in the low resolution mode. The low resolution mode described above has ½ the output resolution in the horizontal direction compared to the high resolution mode described with the embodiment. When this is done, as shown in FIG. 31, the actual size of one block consisting of 4×2 dots formed on the printing paper is twice the size in the horizontal direction as when in the high resolution mode. Because of that, with the halftone process during the low resolution mode, by performing the encoding process and the decoding process as described hereafter, the output image can be made to the proper size.

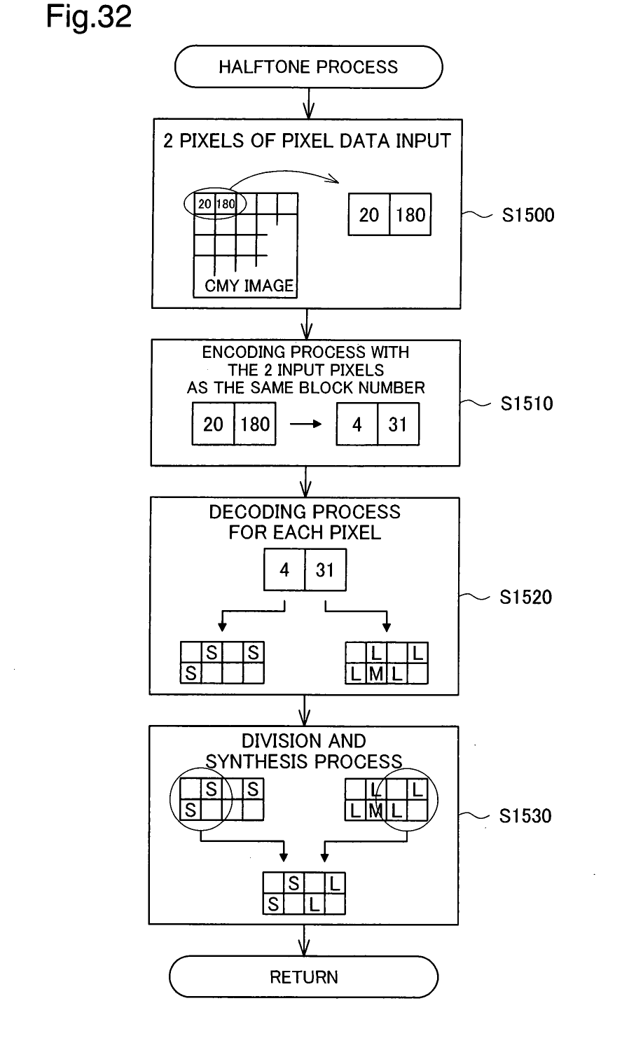

FIG. 32 is a flow chart giving a summary representation of the halftone process when in the low resolution mode. First, the image processing ASIC 155 inputs the image data of 2 adjacent pixels in the X direction from the CMY image (step S1500).

Next, the encoding unit 410 of the image processing ASIC 155 performs encoding processing (step S1510) respectively with the 2 pixels input at the aforementioned step S1500 belonging to the same block number.

After the encoding process, the decoding unit 420 of the image processing ASIC 155 performs the decoding process on each pixel when the 2 pixels of encoded values are input from the encoding unit 410 via the intermediate buffer BF, and the 2 blocks of dot arrangement data is obtained from the decoding table DecTBL (step S1520).

When 2 blocks of dot arrangement data are obtained, the decoding unit 420 performs the dot arrangement data division and synthesis process (step S1530). With this division and synthesis process, the decoding unit 420 obtains the left half (2×2) dot arrangement data from the dot arrangement data (4×2) corresponding to the pixels positioned at the left side in the CMY image, and furthermore, it obtains the right half (2×2) dot arrangement data from the dot arrangement data (4×2) corresponding to the pixels positioned at the right side in the CMY image. Then, if these obtained 2×2 dot arrangement data are arranged side by side and synthesized, the halftone processing of 1 block is completed.

With the fourth modification described above, along with a decrease in the resolution, even when the actual size of 1 block is enlarged, by dividing and linking 2 pixels of dot arrangement data, it is possible to keep the actual size of the output image to the same size as the actual size of the output image using the high resolution mode. Also, even when 2 dot arrangement data are respectively divided and synthesized, each dot arrangement data is generated from the same block number, so it is possible to suppress unintentional increase of the dot count within the block after division and synthesis. Therefore, even if output is performed with the resolution decreased, it is possible to suppress degradation of image quality by losing a part of text or lines that existed in the input image.

(H5) Fifth Modification:

With the embodiment described above, the printer 100 was a compound type, and it alone performed from input of the image data to halftone processing and up to ink eject control. In contrast to this, it is also possible to connect a computer to the printer 100, and at the computer, to execute inputting of the image data and up to part of the halftone process, specifically, the encoding process. With this kind of constitution, by installing a specified program in the computer, it is possible to realize the initialization process and the halftone process noted in the embodiment. The printer 100, when it receives the encoded value via a printer cable or the like from the computer, performs the decoding process according to that encoded value, controls the printing mechanism, and performs printing to the printing paper.

In this way, if up to the encoding process is executed by the computer, image data having 8-bit (256 gradation) data size for each C, M, Y, and K are converted to 5-bit encoded values, so it is possible to reduce the communication volume between the computer and the printer 100. As a result, it is possible to increase the overall printing speed.

I. Other Aspects:

The present invention can be implemented with the following aspects. For example, for the image processing device, the conversion table generating means can also consist of:

a dot count setting means that, for each of the small area dither matrixes, across the scope of values that can be used for the image data, compares the generation volume and the cumulative volume for each dot of a plurality of times set in advance with the threshold values included in the threshold value data, and uniquely sets the generation count for each of the plurality of dot types based on the size relationship, and

a means for generating the conversion table that, for each of the small area dither matrixes, generates the arrangement pattern by arranging each dot for which the generation count was set across the scope of values that can be used by the image data according to the arrangement restoration data, and correlating the arrangement pattern to the values that can be used by the image data and each of the small area dither matrixes and recording them in the conversion table.

With this kind of constitution, it is possible to arrange the plurality of types of dots based on the threshold value data and the arrangement restoration data and to generate the dot arrangement pattern, so it is possible to improve the image quality.

It is also possible to have the dot count setting means of the image processing device be a means that references a specified table in which the image data and each generation volume of the plurality of types of dots are correlated, and the generation volume is set for each dot. With this kind of constitution, it is easily possible to set the dot generation volume corresponding to the image data, so it is possible to make the generation of the conversion table faster.

Alternatively, the dot count setting means of the image processing device can also comprise:

means that, for one type of dot of the plurality of types of dots, compares in sequence the generation volume and the threshold values within the threshold value data, and for the one type of dot, sets the generation count according to the number of comparisons when a specified relationship is reached between that generation volume and that threshold value, and

means that accumulates the generation volume for another type of dot among the plurality of types of dots and the generation volume set for the one type of dot, compares in sequence the accumulated generation volume and the threshold values excluding the threshold values already compared among the threshold values within the threshold value data, and sets the generation count for the other type of dot according to the comparison count when a specified relationship is reached between the accumulated generation volume and the threshold value.

With this kind of constitution, by sequentially comparing the generation volume of the one type of dot and the threshold value within the small area dither matrix, the generation count of that one type of dot is set, and furthermore, by sequentially comparing the accumulated generation volume of the other type of dot generation volume and the previously described accumulated generation volume of the one type of dot with the threshold values excluding the already compared threshold values, the generation count of the other type of dot is set. Therefore, the number of each dot generated within the small area dither matrix can be set to the number of each dot that can be arranged within that matrix without being superimposed, and it is possible to improve the image quality of the output image.

For this constitution, when multiple types of dots of different sizes can be output, if the generation count is set from the large size dots, it is possible to arrange with priority the large dots which stand out the most on the output image at the locations at which there are the low threshold values within the dither matrix. Typically, the lower the threshold value, the better the dispersibility for arrangement within the dither matrix, so by doing this, it is possible to disperse and arrange the dots that stand out, and it is possible to further improve the image quality of the output image.

Furthermore, for the image processing device, as the arrangement restoration data in the initial data that the storage means stores, it is also possible to have the sequence values allocated in ascending order to each threshold value arranged within the small area dither matrix be recorded according to the arrangement of threshold values within that small area dither matrix. With this kind of constitution, the sequence values allocated uniquely in the value sequence of the threshold values are recorded in the initial data according to the threshold value arrangement, so if dots are arranged according to the sequence represented by those sequence values, it is easy to generate the dot arrangement pattern.

For this kind of image processing device, sequence values are allocated in ascending order to each threshold value arranged in the small area dither matrix for the initial data stored by the storage means, and the position data indicating the location at which the sequence values are positioned within the small area dither matrix can also be recorded as the arrangement restoration data. With this kind of constitution, the position data indicating the position of the sequence values is recorded in the initial data, so it becomes possible to easily generate the dot arrangement pattern based on that position.

For the image processing device of the present invention, the initial data stored by the storage means has a plurality of entries prepared according to the number of threshold values within the small area dither matrix, the threshold values are respectively recorded in part of each entry, and it is also possible to respectively record the arrangement restoration data in the other parts of each entry. With this kind of constitution, it is possible to easily obtain the necessary threshold values and sequence values when generating the dot arrangement pattern simply by referencing each entry in sequence.

For the image processing device, it is possible to have each of the entries of the initial data stored by the storage means can have 2 byte data length, the threshold values be data each exceeding 1 byte, and the arrangement restoration data each be data of less than 1 byte. With this kind of constitution, it is possible to manage initial data in 2 byte units, so it is easy to perform address calculation and the like when referencing the initial data. Also, even when the threshold values are data exceeding 1 byte and less than 2 bytes, it is possible to store sequence data of less than 1 byte in the remaining part within the entry, so it is possible to efficiently store the data.

The present invention should not be interpreted as being limited in any way by the aforementioned embodiments, modifications, or other aspects, and the protected scope of the present invention of course is interpreted along the spirit of the claims and the present invention.

What is claimed is:

1. An image processing device that converts image data to data for printing by forming dots on a printing medium, the device comprising:
a storage unit that takes out from a large area dither matrix, in which are arranged threshold values that set whether dots are on or off within a specified area, a small area dither matrix that is an area smaller than that, including a consolidation of a specified number of threshold values, and stores threshold value data for which the plurality of threshold values contained in each of the small area dither matrices are realigned in size order and initial data on which is recorded arrangement restoration data representing an arrangement of the threshold values within each of the small area dither matrices; and
a conversion table generating unit that generates a conversion table based on the threshold value data and the initial data provided at each of the small area dither matrices, the conversion table is used for converting the image data to a dot arrangement pattern.

2. An image processing device in accordance with claim 1, wherein
said conversion table generating unit comprising:
a dot count setting unit that compares a cumulative volume with the realigned threshold values contained in the threshold value data over a range of the image data at each of the small area dither matrices, the cumulative volume is summed of a generation volume determined at each of predetermined types of dots, and sets a unique generation count for each of the plurality of types of dots based on a result of the comparison; and,
a unit that generates the arrangement pattern by arranging each dot for which the generation count over a range of the image data at each of the small area dither matrices, and configures the conversion table by storing the arrangement pattern in the conversion table, correlating the arrangement pattern to each of the values of the image data at each of the small area dither matrices.

3. An image processing device in accordance with claim 2, wherein
said dot count setting unit references a specified table in which the image data and each generation volume of the predetermined types of dots are correlated, and sets the generation volume for each dot.

4. An image processing device in accordance with claim 2, wherein
the dot count setting unit comprises:
a unit that sets the generation count for the one type of dot according to the comparison count when, of the plurality of type of dots, a sequential comparison is done of the generation volume for one type of dot and the threshold values within the threshold value data, and the generation volume and the threshold value reach a specified relationship; and
a unit that sets the generation count for the other type of dots according to the comparison count when, of the plurality of types of dots, the generation volume for the other type of dots and the generation volume set for the one type of dots are accumulated, and a sequential comparison is done of the accumulated generation volume and the threshold values of the threshold values within the threshold value data excluding the threshold values that were already compared, and the threshold generation volume and the threshold value reaches a specified relationship.

5. An image processing device in accordance with claim 1, wherein
in the initial data stored by said storage unit, as the arrangement restoration data, sequence values allocated in ascending order to each threshold value arranged within the small area dither matrix are recorded according to the arrangement of the threshold values within the small area dither matrix.

6. An image processing device in accordance with claim 1, wherein
in the initial data stored by said storage unit, with sequence values allocated in ascending order to each threshold value arranged within the small area dither matrix, recorded as the arrangement restoration data is position data indicating the location at which the sequence value is positioned within the small area dither matrix.

7. An image processing device in accordance with claim 1, wherein
the initial data stored by said storage unit comprises a plurality of entries prepared according to the number of threshold values within the small area dither matrix, each of the threshold values is recorded in part of each of the entries, and each of the arrangement restoration data is recorded in the other part of each of the entries.

8. An image processing device in accordance with claim 7, wherein
each of the entries of the initial data stored by said storage unit has a 2-byte data length, the threshold values are each data exceeding 1 byte, and the arrangement restoration data are each data smaller than 1 byte.

9. An initial data that said image processing device in accordance with claim 1 uses for generating a conversion table that converts an image data to a dot arrangement pattern, the initial data comprises:
threshold value data for which are realigned in a size sequence a plurality of threshold values contained in each of small area dither matrices, the small dither matrices includes consolidations of a specified number of threshold values taken from a large area dither matrix in which are arranged threshold values that set whether dots are on and off within a specified area; and
arrangement restoration data that represents an arrangement of threshold values within each of the small area dither matrices.

10. A method of generating a conversion table that converts the image data to dot data for printing by forming dots on a printing medium, the method comprising:
preparing a large area dither matrix in which are arranged threshold values that set whether dots within a specified area are on or off,
taking out a small area dither matrix including a consolidation of a specified number of threshold values from the large area dither matrix, the small area dither matrix is an area smaller than that;
realigning in size sequence a plurality of threshold values contained in each of the small area dither matrices,
generating arrangement restoration data that represents an arrangement of threshold values within each of the small area dither matrices, and
generating the conversion table based on the threshold value data and the arrangement restoration data provided at each of the small area dither matrices, the conversion table is used for converting the image data to an arrangement pattern of the dots.
